(19) United States
(12) Patent Application Publication
(10) Pub. No.: US 2015/0315442 A1
(43) Pub. Date: Nov. 5, 2015

(54) Production Method of a Novel Polishing Alumina

(71) Applicant: ALBEMARLE EUROPE SPRL, Louvain-la-Neuve (BE)

(72) Inventor: Henning Hofius, Aachen (DE)

(21) Appl. No.: 14/648,283

(22) PCT Filed: Dec. 23, 2013
(86) PCT No.: PCT/EP2013/077933

§ 371 Date: May 29, 2015

Related U.S. Application Data
(60) Provisional application No. 61/746,770, filed on Dec. 28, 2012.

(51) Int. Cl. C09K 3/14

(52) U.S. Cl. CPC C09K 3/1427

(57) ABSTRACT

Provided is a method for the formation of particulate compounds of selectable size characteristics, which method includes supporting a slurried particulate precursor on a porous support; heating the support such that aggregates of the particulate compound are formed, and desagglomerating the aggregates into their component particulate. In a preferred embodiment, an aqueous slurry of alumina particulate which has not undergone the alpha transition is contacted with a porous support having defined pore and cavity sizes, such that the slurry occupies at least some of the interstices of the porous support. The slurry and support are heated such that the alumina precursor slurry undergoes the alpha transition. The alpha alumina product is then particulated. The support is of such a material that it is either lost through combustion during heating or otherwise removable after heating, such as during or after particulation, without destroying the particle characteristics imparted by the porous support. Additionally, in a further embodiment, co-components are added to the slurry in order to impart desired properties to the particulated product.

### TECHNICAL FIELD

The present invention is directed toward the preparation of alpha alumina particulates from aluminum oxide, aluminum hydroxide, aluminum salts and other aluminum compound precursors. More generally, the present invention is directed toward the formation of particulate, via heating, from particulate or solution precursors.

### BACKGROUND

Alpha alumina powders are routinely produced by calcination from agglomerated/aggregated alumina precursors. Many such precursors can be prepared by known processes, such as processes which include the Bayer method for purifying raw, aluminum-containing ores. However, the high temperatures required to cause the precursors to undergo the transition to alpha alumina complicates the production of powdered alpha alumina products. Due to the erratic thermal conduction throughout the powdered mass, which is generally loosely disposed, properties such as particle size and particle size distribution are difficult to control. Typically, the calcination process can form hard agglomerates and aggregates. Such agglomerated products commonly must be further processed through milling or other particulation or comminution steps which require additional time and energy.

In general, the thermal calcination, at high temperatures, of loose particulates tends to result in the formation of aggregates and/or agglomerates. One reason that fine powders are difficult to calcine or anneal is that invariably, significant amounts of dust are present in the powder prior to high temperature exposure, or are produced in the calcination process, or both.

Especially in the case of directly fired gas furnaces, the high temperature required in order for the feedstock or precursor to undergo the alpha transition can cause extensive aggregation and/or agglomeration, such that the grinding process, rather than simply breaking apart particles which are lightly agglomerated, actually has to grind the agglomerates into new particles. As a result, intrinsic particulate properties of feedstocks/precursors, such as shape, particle size, particle size distribution and the like are generally not reproduced in the final product. Other particle properties, such as surface qualities, are also affected by the lack of homogeneous thermal conduction throughout loosely powdered feedstocks/precursors during the required heating for calcination and alpha transition.

It has heretofore been often thought by those of skill in the art that the preparation of alumina powders from Al₂O₃ feedstocks or precursors which have not (or have not completely) undergone the transition to alpha alumina or which are lower in the thermal transition sequence than the resulting alpha alumina (for example, gibbsite α-Al(OH)₃, bayerite β-Al(OH)₃, nordstrandite γ-Al(OH)₃, diaspore α-AlOOH, boehmite γ-AlOOH, χ-alumina, η-alumina, γ-alumina, δ-alumina, κ-alumina, θ-alumina, α-Al₂O₃) would not be more easily accomplished in the wet state than in the dry state, because raising the temperature to the level required for the phase transition to take place would evaporate the liquid phase well before the transition temperatures are reached. Thus, any possible advantage associated with the use of water, such as possible uniform heating and consequently less agglomeration, would not materialize.

The issues outlined above can be generalized to encompass heat-mediated transitions between other alumina phases and states between them, as long as the state of the resulting mineral phase is higher than state of the feedstock. As a result, the agglomeration and other issues associated with the required high temperatures would continue to occur.

Other issues have arisen with respect to the agglomeration of alumina particulate. Methods for the preparation of alpha alumina particulate often give particle size distributions which have an incidence of relatively large particles. For instance, even a small incidence of particles above 100 microns, and in many cases above just 5 microns, can compromise the polishing ability of a particulate, rendering it unsuitable for many surface engineering applications, a common one of which is surface polishing. For example, polishing slurries for nickel-plated hard disks generally should be carried out with slurries in which particles are much less than 1 μm. Often such particles are particle size distribution outliers, and they can be a result of mechanical grinding or comminution such as is commonly done after calcination. In some situations, such large particles can be a result of earlier steps in the preparation of alpha alumina, such as oversize particles present in feedstocks.

Overall, regardless of their origin, oversized particles can impair the usefulness of the overall particulate in capacities in which precision is required. For example, particulate which is intended to be used as a surface engineering agent, such as, for example, polishing, grinding and other particulates, can cause damage to surfaces if such large particles are present. However, the removal of such oversized particulate is expensive and time consuming, requiring extra processing steps.

Yet further issues arise in the preparation of alpha alumina particulate through methods which include the formation of particulate from solution, with or without seed particles. Not only is the issue of agglomeration present, but the additional issue of original particle size control is present. Unlike the situation in which particulate size is related to that of the precursor which is used, particulate of pre-alpha alumina is formed and calcined during the same temperature ramp. Thus, formation and agglomeration become less distinguishable. Nevertheless, such situations generally at least require vigorous des agglomeration, and generally require grinding.

An alpha alumina particulate-forming method which minimizes agglomeration and other mechanisms for the production of large particulate and which has the flexibility to accommodate both methods of the particulate formation would be a significant advance in the art.

### BRIEF DESCRIPTION OF THE INVENTION

It has been found that when finely sized alumina precursors which have not undergone the alpha transition are slurried and applied to or otherwise contacted with an open-celled porous support, such that at least a portion of the slurry resides in the interstices of the porous support, and is subsequently heated to undergo the alpha transition, the resulting alpha alumina product can be particulated easily into loosely bound, easily desagglomerable particles having properties which, depending upon the relative size of the precursors and the pores, correlate with either 1) size and other properties of the finely-sized precursors, or 2) the pore and cavity size properties of the porous support. The porous support is preferably of such a material that it is lost through combustion during the heating operation. Thus the present invention involves a process for the preparation of a mineral particulate, said process comprising the steps of:
a) applying a transitionable material to a porous polymeric support;
b) raising the temperature of the applied transitionable material and the support to one or more temperatures for a time to give a resulting particulate or a resulting agglomerate;
c) if a resulting agglomerate is given in b), desagglomerating some or all of said resulting agglomerate to give a resulting particulate;
   wherein said porous support is polymeric and some or all of said porous support is reduced through combustion or thermal degradation in b); or wherein a resulting agglomerate is formed and said porous support is particulated with said agglomerate and subsequently some or all of said support is separated from said resulting particulate.

By “transitionable material” is meant a material which has the capacity, upon heating to undergo a phase transition in response to a heating treatment as described herein. One example given herein is a slurry comprising sub-alpha alumina particulate which undergoes a phase transition, such as to alpha alumina upon exposure to the heat treatment. Another example given herein is a solution which forms alumina particulate upon subjection to the heating treatment, regardless of whether or not the crystals undergo phase transition in response to the heat applied. In some embodiments, the solution comprises particles which serve as seeds for the particle growth. Further examples include slurries of mixtures of two or more different particulates which together undergo a transition to a mineral structure. The foregoing are non-limiting examples.

It is surprising that slurries coupled with a support should reduce or eliminate such agglomeration because one could expect the liquid phase of the slurry to quickly be lost at relatively low temperatures during the temperature ramp to alpha transition temperatures, leading to the problematic behavior, seen with dry powders, of sedimentation and hard agglomerate formation at high temperatures. Furthermore, one could expect that the conduction of heat through the slurry/support complex would either be hindered by the inner cavity walls of the support, or, if the support were lost through combustion, extensive agglomeration would be expected at transition temperatures and particularly alpha transition temperatures.

It has also been found that the above method has the advantage that the support can significantly or effectively exclude particles which are above a size which correlates with the size of the pores in the open-celled support. The exclusion is such that the presence of “oversized” particles can be minimized in or eliminated from the final desagglomerated product.

By suspending or dispersing the feedstock in a liquid, forming a slurry, and applying it to a porous support, and subjecting the supported particulate to a temperature and time controlled firing process to cause a phase transition or reaction, it is possible to fully utilize even the particles in the smallest fraction, a fraction which has increased the likelihood of agglomeration in prior methods. The method furthermore enables the exclusion of over-sized particles prior to the calcination stage, because, among other things, oversized particles will generally not fit into support pores which are smaller than the particle. The use of ultrafine powders at such an initial stage results in less energy expenditures for comminution operations because oversized particles generally do not have to be removed or ground into smaller particles. The calcination of such uniformly fine powders and the properties of the resulting post-calcination products open a broad range of potential uses such as catalysis, adsorption, filler, high-performance ceramics, and high-sophisticated surface treatment.

It should be noted that the present invention is not limited to the formation of only alpha alumina particulate products. More generally, disclosed is a method for controlling the particulate size distribution of a product formed when a particulate precursor undergoes a heat-mediated phase transition on a porous support. The present method is applicable to the formation of alumina particulate product of a sub-alpha phase from particulate which is lower in the phase transition hierarchy than the phase of the product. In an embodiment, the present method is also applicable to heat mediated phase transitions between sub-alpha alumina particulates, as indicated herein.

In another embodiment, the present invention is also applicable to the heat mediated formation of product particulate from a particulate composite comprising particulates of more than one compound, as described herein with respect to the formation of, for example, mineral compounds, such as, for example, spinel compounds, from a binary or trinary particulate system.

In yet another embodiment, as mentioned above, the present invention includes within its ambit the heat-mediated formation of particles from solutions, and/or in some embodiments, seeded solutions, by the heating of the solution on a porous support.

In other embodiments, the precursors can contain two or more component phases (even including alpha alumina in some embodiments) or a composite of phases. The final phase of at least one of the component phases of the product is at a higher thermal stage or, in other embodiments, a chemically changed composite product is formed.

The invention is not limited solely to alpha alumina-free feedstock(s). Alpha alumina can also be deployed as a feedstock, or it can participate as a reaction partner in the formation of “multinary” mineral compounds. If the alpha alumina feedstock contains amounts of non-alpha phase, the thermally reacted product provides the feature of a higher alpha alumina phase material, respectively the remains of non-alpha phase are transferred to alpha phase. Even pure-phase alpha alumina particles can be thermally modified showing the pattern of crystal growth and/or the curation of distorted crystals. Furthermore a change in the grain shape results by the thermal use of dopands/mineralizing agents and/or exceeding temperature. Aside from that, the use of a second mineral phase favors the formation of a solid solution.

See Examples 33 and 41 which show use of alpha alumina in combination with mineralizing agent NaBF₄. Starting component MRS-1 has an alpha content >95 wt % and a specific surface area (BET) of 3.5 m²/g. After thermal treatment BET is 1 m²/g, only. This indicates crystal growth and change in crystal shape. SEM photo is available. See Examples 39 and 44 which show use of alpha alumina MRS-1 as reactant with Mg(OH)₂ powder forming magnesium spinel. SEM available.

### BRIEF DESCRIPTIONS OF THE DRAWINGS

FIG. 1: Typical particulate feedstock used for calcination of alumina.

FIG. 2: Unground post-calcination alumina prepared by a method which includes the calcination of a dry powder feedstock.

FIG. 3: Grain size analysis of the particulate resulting from jet-milling the calcined alumina product of FIG. 2.

FIG. 4: Jet-milled particulate prepared from granulate formed by calcination of a dry powder.

FIG. 5: Grain size analysis of the particulate resulting from jet-milling the alumina of FIG. 4.

FIG. 6: A finely precipitated feedstock particulate essentially free of aggregates and agglomerates.

FIG. 7: The grain size distribution of the particulate feedstock illustrated in FIG. 6.

FIG. 8.1: Post-desagglomerated alpha alumina particulate prepared from the particulate of FIGS. 6 and 7.

FIG. 8.2: Higher resolution of subject 8.1, aggregated semi-nanosized primary particles from phase transition to alpha alumina.

FIG. 9: The grain size of the post-desagglomeration alpha alumina product prepared from the particulate of FIGS. 6 and 7.

FIG. 10: Particulate prepared according to the present inventive method with the addition of 0.5 wt % NaBF₄.

FIG. 11: Particulate prepared according to the present inventive method with the addition of 0.5 wt % AlF₃.

FIG. 12: Particulate produced according to the method of the present invention from particulate feedstock OL-107 LEO treated with 2 wt % Na₂PO₃F.

FIG. 13: Particulate formed according to the inventive method from unseeded Aluminum formate solution (5 wt % of Al₂O₃) which has been thermally treated at 1200° C.

FIG. 14: Particulate formed according to the present invention from Aluminum diformate solution (10 wt % of Al₂O₃) with addition of 2 g alpha alumina seeds.

FIG. 15: A chart of alumina phases and transition temperatures.

FIG. 16: Feedstock PN-202, mostly alpha phase at around 85 wt % and correspondingly 15 wt % sub-alpha phase.

FIG. 17: Higher thermal transition of PN-202 by treatment with AlF3 at a temperature range significantly above the threshold of alpha-formation resulting in a product with more than 99 wt % alpha alumina phase.

FIG. 18: Feedstock MRS-1, alpha alumina based and greater than 95 wt % alpha phase.

FIG. 19: Higher thermal transition of MRS-1 by treatment with NaBF4 at a temperature range significantly above the threshold of alpha-formation resulting in a product with more than 99 wt % alpha alumina phase.

FIG. 20: Spinel formation by MRS-1 (alpha phase alumina) with magnesium dioxide; the thermal reaction product spinel is finer than the higher alpha transitioned alumina feedstock MRS-1.

### DETAILED DESCRIPTION OF THE INVENTION

While the product particulate features can, in many embodiments correspond to those of the feedstock particulate, it is also true that the pore size of the support generally has an effect on the size of the undesagglomerated aggregate which results from the heating. In addition to the size-exclusionary effect mentioned herein, the support can also result in an aggregate which corresponds in size and size distribution to the analogous pore size characteristics of the porous support. As mentioned above, these aggregates can then be desagglomerated into particulate having size characteristics correlating with those of the feedstock particulate. In the absence of a support, regardless of whether the particulate has a liquid component (i.e., a slurry), the result of exposure to phase change temperatures generally gives a hard cake which must be desagglomerated or even ground.

The particle size of the product after comminution can be generally determined by initial grain size distribution of the particulate precursors. By “generally determined,” it is meant that the product particulate size distribution correlates with the precursor particle distribution. This correlation may not be exact. For example, certain changes in phase may be accompanied by a change in volume. For example, consider the case of an approximately spherical primary 2 μm particle (not an aggregate) undergoing a transition from gibbsite to alpha alumina such as corundum. If the change in specific weight is taken into account, it can be appreciated that the loss in diameter will be about 15%.

While the change can be significant, such a change can be accounted for by doing a test run in which the product particle size distribution is measured and the degree of size change can be assessed. A typical method for determination of the particle size distribution is the measurement by laser diffraction, such as with a laser granulometer, such as a Cilas 1064. Routinely, BET measurements can be conducted by Gemini VI. Once the size change of a particular material undergoing a phase change has been ascertained, a desired resulting particle size and size distribution can be obtained by choice of properly-sized precursors. In general, the present inventive method offers the ability to control the particle and particle size distribution of a formed particulate by starting with a particulate precursor having known particle size and size distribution characteristics,

The present invention can be practiced under a modification in which a particle-forming solution, optionally comprising seed particulate, is applied to or exposed to a porous support, and subjected to a temperature ramp as is common in the calcination of alumina. Particulate formation occurs on the seed particle, with calcination (i.e., phase transition) subsequently occurring in the formed particle volume at higher temperatures.

Seeding materials are preferably stable in that they do not undergo phase transition under the applied thermal conditions. They are preferably of a crystal structure which is similar to corundum. Alpha alumina seeds are preferred in systems comprised of only alumina compounds, but other compounds having related crystal structures to corundum, such as, for example, alpha ferric oxide and alpha chromium oxide can be used.

Seeds can affect the phase transition to alpha alumina at low concentration. A seed content around 0.1 weight of the feedstock(s) and even lower can decrease the transition temperature by as much as a few tens of ° C. A higher seed content promotes an even lower temperature transition. A seed content of around 10 weight % of the feedstock(s) might decrease the transition temperature by significantly more than 100° C.

Metal containing modifying agents in the oxide form or salts, which thermally decompose to the oxide form of the metal, can be applied as synergist. Optionally a synergist can be used by itself or in association with other mineral oxide compounds. It is not required that the metal oxide be a compound which is formed of only one oxide component. It can be a compound, of more than one oxide component, such as magnesium aluminate (MgO.Al₂O₃), aluminum titanate (Al₂O₃.TiO₂), cordierite (Mg,Fe²⁺)₂(Al₂Si)^{[4]}[Al₂Si₄O₁₈] and others, solid solutions of mineral oxides, where one metal ion is substituted by another cation, or even a component of the liquidus in accordance with chemical equilibrium. Synergists include iron oxide, manganese oxide, chromium oxide, lanthanum oxide, vanadia, ceria, yttria, magnesia, zirconia, silica, titania, and the like or related salts, which can be thermally transferred into the oxide form.

The particle size of the product particulate is correlated with by the intrinsic properties of the feedstock. In the case of the particle formation embodiment, the size and number of seeds (weight ratio) have an impact on lowering the transition temperature and on increasing of the degree of alpha formation for a given heat treatment, with higher seed content giving greater reduction in transition temperature. In general, seeding lowers the transformation enthalpy to alpha alumina, and multiple sites are available on the alpha seed's surface for alpha alumina formation.

In the absence of seeds, nucleation is affected by the thermal treatment temperature profile, time, and maximum temperature. The thermal treatment affects the degree of transition and the final particle size. The pore size of the support limits the size of the loosely bound agglomerate. Without desiring to be bound by theory, it is thought that the interconnecting matter of the pore system of a polymeric support, with its edges and contact points, functions as a nucleating agent. At higher temperatures the carbon remains of the burnt support are also thought to function as nucleating agent. Thus, in general, because the support disintegrates at higher temperatures, it exerts a diminishing constraint on the particle size, the higher the temperature of the transition, the larger the average final particle size.

The method of the invention includes diverse embodiments with respect to which materials are applied to a support. In some embodiments, slurries are applied, either comprised of particles which undergo a transition when subjected to heat or seed particles which serve as nuclei for particles which form from solution during heating. In other embodiments, solutions are applied to the support, and particles are formed from the solutions during heating. As indicated infra, both the embodiments which start with a particulate which is phase-transformed and those which form a particulate (regardless of whether the formed particulate is subsequently phase-transformed during the heat treatment) constitute the application of a “transitionable material” to the support. The term includes, but is not limited to, additives, such as, for example, those described herein.

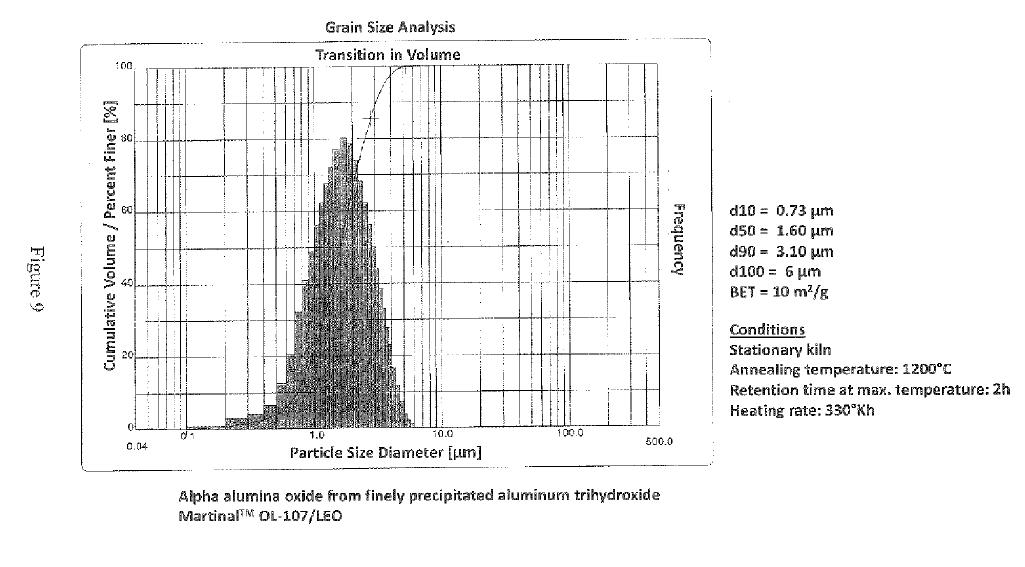

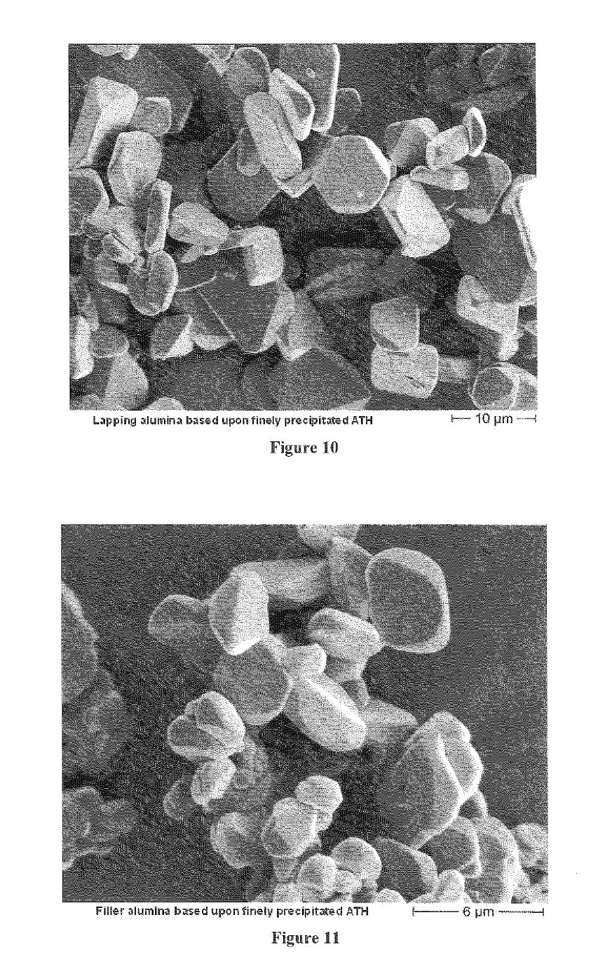

Additionally, in further embodiments, co-components are added to the slurry in order to impart additional properties to the particulated product. Co-components can reduce the alpha alumina transition temperature. In particular, in the case of the particle formation embodiment (seeded or unseeded), co-components can be included which affect particle size, size distribution, aspect ratio, and the like. For example, additives which have an influence on particle morphology include boron compounds and salts as H₃BO₃, Na₂[B₄O₅(OH)₄].8H₂O, NaCa[B₅O₆(OH)₆].5H₂O, (Mg,Fe)₃[ClB₇O₁₃], Nickel-Strunz floride as NaF, Na₃[AlF₆], KF, K₃[AlF₆], Na₂PO₃F, NaB_{F}4, BF₃, CaF₂, AlF₃, CeF₃, VF₃, VF₅, VOF₃, AlCl₃, polyaluminum chloride, etc., other halides and halogen containing salts, compounds and gases (Cl₂, F₂, and the like). Salts/compounds of rare earth minerals as cerium acetate, lanthanum carbonate, lanthanum chloride, yttrium chloride, etc., synergists as MgO, TiO₂, Cr₂O₃, silica, etc. (See FIGS. 10-12).

Such co-components may not necessarily be present in the final product as in some cases, they may evaporate during the thermal process. However, such compounds can function in the slurry as surface active compounds which alter the surface of the particulate feedstock. Organic and inorganic acids, such as, for example, formic acid, acetic acid, citric acid, nitric acid, hydrochloric acid, sulphuric acid, and the like, can be employed as surface modifiers being present in the initial phase of the process but get lost due to thermal treatment. Such acids are preferably used to acidify the slurry such that it has a pH value of less than about 5 and preferably less than about 2.5. Without desiring to be bound by theory, it is thought that the acid reacts with the surface of the alumina feedstock or other particulates in forming nano-dimensioned “shells” of corresponding aluminium salts, such as, for example, aluminium sulphate, aluminium acetate, and the like. After the slurry has been thermally treated and transformed into a bulk of powder, the “shell” of different composition than the “core” is converted to alpha alumina different in pattern than the alpha alumina of the “core”. The transformation of the aluminium salt-like surface to alpha alumina might occur at lower temperature than the core. For instance, this effect can be applied for high gloss polishing applications of plastic, metal and inorganic material surfaces. A toughened “shell” can give an increased removal rate of surface imperfections, and after the shell wears, the softer core material smoothes and flattens the surface of the planar material.

A combination of sulphuric acid and ammonium sulphate also alters the surface of the aluminium hydroxide particle and can be considered as surface modifier. The use of ammonium by itself is effective Example 2 shows the use of an acid as a surface modifier, and Examples 27 and 28 further combine with cerium acetate.

The present process gives many advantages over other processes for the formation of alpha alumina particulate, activated aluminas/transition aluminas, and other mineral compounds. The post-transition product is much more easily desagglomerated than with other methods: instead of the hard; agglomerated, caked, compressed product so often observed, the alpha alumina product is easily separated into fine form, such as particles, granules or relatively loose agglomerates which are, in general, correlated with the particle size properties of the particulate precursor, the pore size properties of the porous support, or both.

With respect to the use of a saggar, because slurry is generally denser than loose powder, the alumina content of the saggar can be increased over what would be observed in the case of a loose powder. Furthermore, settling of alumina is further reduced with the use of a porous support. Thus, the danger of the alumina level in the saggar falling to less than the top of the porous support before or during heating is minimized.

Further advantages with the use of a slurry and porous support are seen in the ease of post-transition processing of the product. The use of a support leads to ease of saggar discharge. Desagglomeration of the product requires less energy than with other processes used to form alpha alumina particulate.

Furthermore, the use of the slurry with the porous support minimizes dust formation which would otherwise be exposed to the convection in a gas-fired kiln. The material is kept stationary in the support, and after the support has been combusted, a loose bulk, having a degree of agglomeration, remains in the saggar. The alpha alumina product can easily be reduced to particles having relatively predictable sizes and size distributions due to the properties of the feedstock, and the improved characteristics of the thermal process.

Advantages of the novel method include the convenient preparation of particulate alumina and other compounds in useful size ranges, including ultra-micron (for example, about 0.1 μm to about 5 μm) and semi-micron (for example, about 5 μm to about 200 μm) by forming a loosely annealed bulk/granulate which can be reduced to particulate by the application of only mild desagglomeration measures. The method enables the use of ultra-fine feedstocks, such as those having sizes in the range of from 0.1 μm to 200 μm, and if desired, such feedstocks can be characterized particle size distributions which would be difficult to obtain by grinding alone. For example, steep and narrow particle size distributions, i.e., particle size distributions having particle size ranges such that they are closely spaced around the mean particle size, can be formed. Common size distributional problems such as large particle size distribution outliers can be nearly eliminated.

In additional embodiments, the inventive process can even be used with super fine feedstocks (having average particle size <1 μm) and even nano-sized feedstocks/precursors (having average particle size <100 nm), leading to controllable, predictable, consistent, and desired properties. Thus the selection or fabrication of particulate precursor can be used as a quality determining step. The need for dust-generating precision grinding or other bulk comminution steps is generally reduced or eliminated. Furthermore, feedstock particles, particularly superfine particles which can lead to dusting, are suspended or dispersed as a slurry inside a porous support. Dust formation is reduced or prevented, which is beneficial in that it generally enables a better exploitation rate of the product as well as reduced operations for handling the dust.

With the process described herein, during high-thermal treatment, formation of solidified and hard aggregates—which are commonly laborious to mill—is suppressed relative to existing processes which involve the heating of dry alumina feedstock. It should be noted that some thermal processes have been used with very fine feedstocks in order to reduce the tendency of agglomeration—for instance the use of a indirectly fired rotary kiln. However, such processes are handicapped by dust formation, as well as the sticking of material to the kiln lining. Consequently, such processes generally entail less control of desired product properties.

With the present process, generally, only an easily performed desagglomeration of the loose, bulky secondarily formed agglomerates (i.e., not present in the precursor, but formed during transition temperatures) would be required after annealing, in order to reduce the agglomerate to its component particulate. As mentioned herein, the phase transition may involve a volume shrinkage, and thus the product particulate may differ in size parameters with respect to the product particulate, an effect which can be accounted for in the selection of feedstock particulate properties.

Desagglomeration can be accomplished by means such as, for example, a jet mill or pin mill. The feedstock can be sized by, for example, precision particulation measures or sorting/separation measures, such as super fine precipitation of the feedstock and/or by milling of the feedstock material. Energy demand, and consequently total milling costs and after-treatment costs are reduced. The need for post-calcination separation procedures is minimized or eliminated. In other embodiments of the present invention, a step involving further milling of the above described particulate can be implemented to further reduce average particle size or otherwise affect the particle size distribution.

Without limiting the invention, it has been found that slurries in which the viscosity is minimized while the solid content is maximized generally exhibit advantages such as increased ease in 1) filling the saggar, applying the slurry to the porous support, and penetrating the pores of the substrate with the slurry. The high filling degree results in an increased amount of material on the substrate, increasing the rate of production. Furthermore, thermal conductivity generally increases with the amount of matter in the kiln. For instance, aluminum trihydroxide slurries having viscosities as low as approximately 100 mPas and solid content of greater than 70 wt % have been used.

The inventive process can be generalized to the formation of particulate and agglomerated mineral products other than alumina products, such as, for example, other minerals which contain aluminum, such as aluminate minerals, such as, for example cobalt aluminate. Other non-alumina, aluminum-containing materials, such as ceramic spinel pigments, can be prepared, particularly from aluminum trihydroxide precursors.

In other embodiments, the inventive process includes within its ambit the preparation of mineral compounds by heating a slurry which is a unary, binary, ternary or higher order mixture of inorganic substances while the slurry is supported on a support which, in some embodiments, is lost to combustion, or in other embodiments, is retained and either separated from the mineral product, or retained as a functional element, such as in the preparation of adsorbent materials as disclosed herein. Furthermore, in some embodiments, the thermally treated particulate/support complex can be used as an insulant material, a heat sink, a filter with specific adsorptive properties.

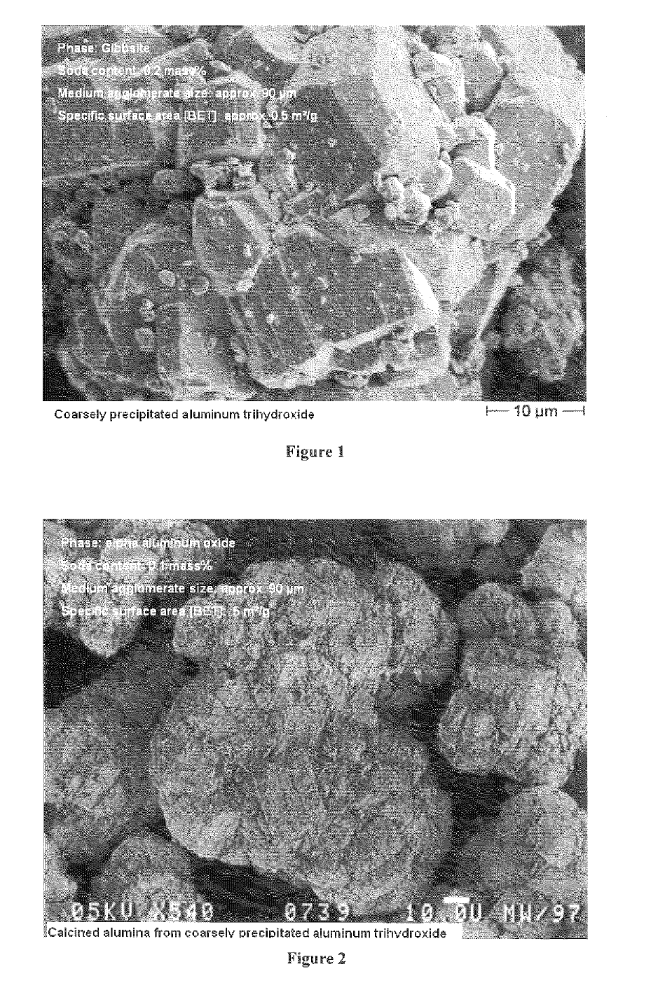

FIG. 1 depicts typical feedstock, which can be used for the calcination of alpha alumina in rotary kilns. This coarsely precipitated aluminum trihydroxide is produced by the Bayer process and has an structure formed by primary particles, which are visibly aggregated into domains and further into larger agglomerates having a median size of approximately 90 microns. Such particles are often not ground or otherwise particulated until after calcination due to the production of dust which can interfere with calcination. The phase pictured is Gibbsite having a soda content of 0.2 mass %, a median agglomerate size of 90 microns, and a specific surface area (BET) of about 0.5 m²/gram.

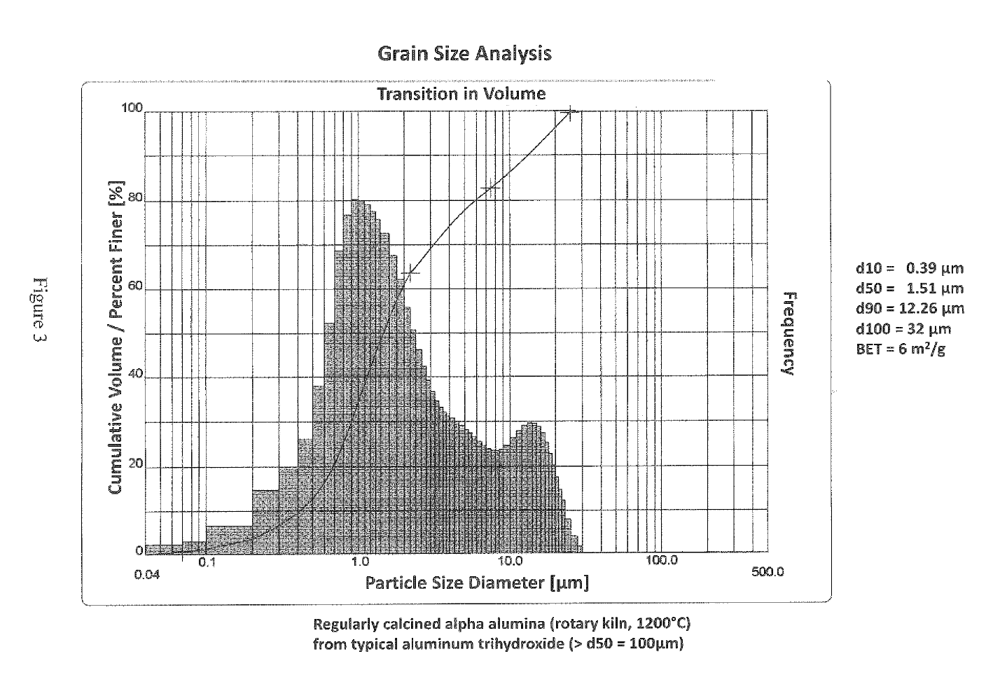

The feedstock of FIG. 1 is used to prepare the unground post-calcination alumina of FIG. 2 by a method which includes the calcination of a dry powder feedstock. This unground calcined alpha alumina from calcination in a rotary kiln exhibits the outer appearance of the feedstock hydrate. The primary alpha alumina particles have an average diameter of approx. 0.6 μm. Generally, heretofore, alumina feedstocks for use in a directly fired rotary kiln have had a reasonable grain size with an average diameter of preferably at least 30 μm, otherwise dust formation occurs in large enough amounts that the uniformity and degree of calcination is difficult to control, giving an inhomogeneously calcined product containing particles which fall within a wide range of specific surface areas, resulting in an inhomogeneous product of a widely varying calcination degree. Prior to the inventive method, the formation of small particles necessarily involved starting with large particle precursors which underwent the alpha or other target transition, but were not ground until after the transition in order to prevent dusting in the kiln.

The grain size distribution of calcined alpha alumina (jet-milled) particulate deriving from alumina of FIGS. 1 and 2 is depicted in FIG. 3. It shows a substantial portion of oversized particles (the peak toward higher particle sizes) which are hard, aggregated matter which could scratch polished surfaces. The particle size distribution has been measured by laser diffraction (Cilas 1064) in the “super fine powder range”.

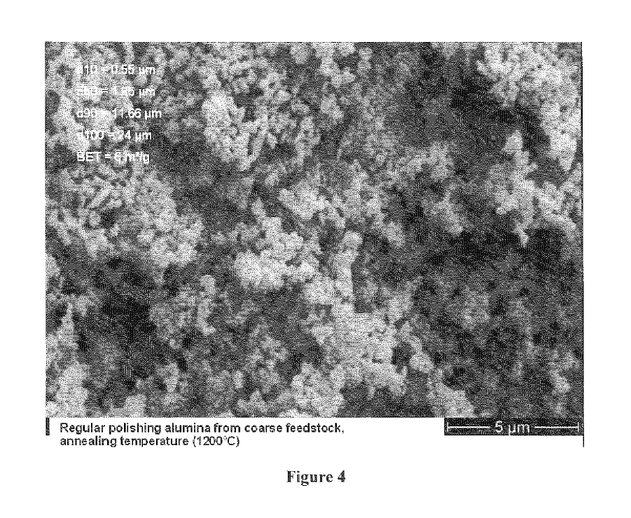

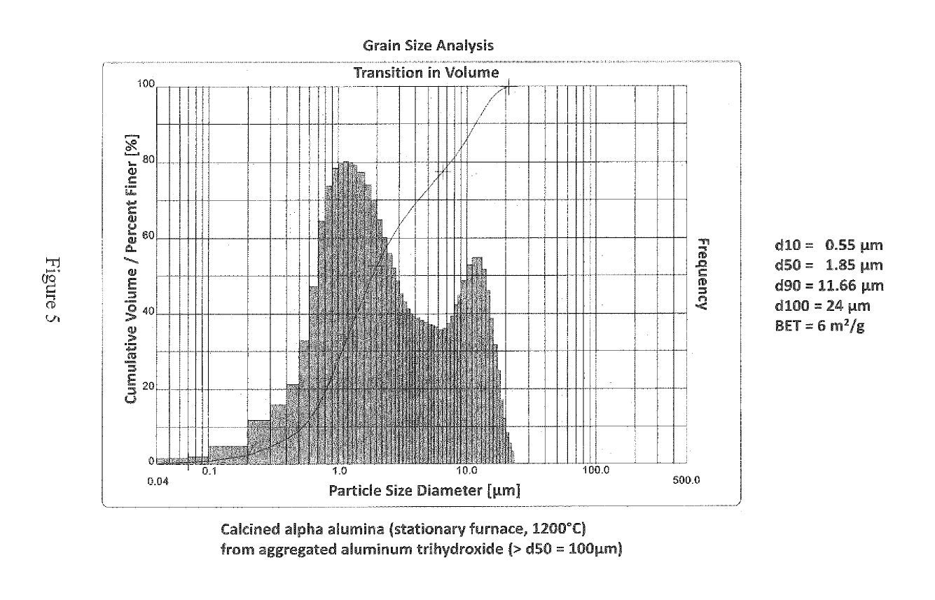

A regular super ground alpha alumina (jet-milled) deriving from extra coarse boehmite feedstock (medium agglomerate size >0.5 mm) which was annealed in a stationary furnace at 1200° C. is depicted in FIG. 4. The grain size distribution, shown in FIG. 5, shows a proportion of oversized particles (the smaller peak toward higher particle sizes), which have not been reduced in size by jet milling and could damage surfaces during polishing. The primary particle size is in the range of 200-300 nm. Coarse aggregates are evident up to 24 μm.

FIG. 5, which depicts the particle size distribution of the stationary annealed jet-milled alpha alumina of FIG. 4, above, provides a more detailed pattern of the coarser particle fraction after jet milling.

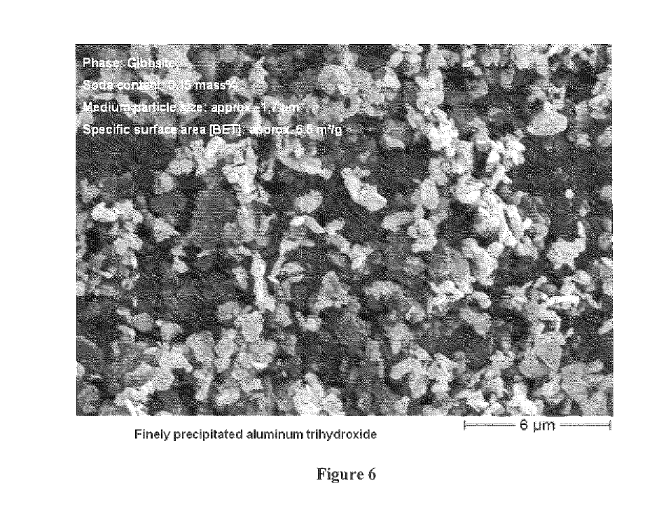

FIG. 6 depicts super fine hydrate crystallized from the Bayer process—a specific feedstock for the calcination of alpha alumina—is processed by the use of a porous support in a stationary kiln. Finely precipitated aluminum trihydroxide is essentially aggregate-/agglomerate-free.

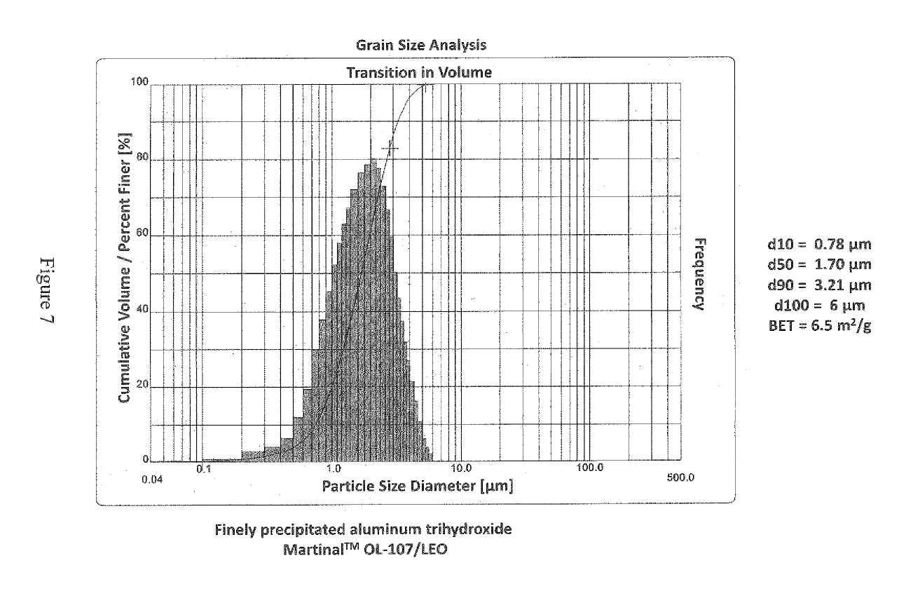

FIG. 7 depicts the grain size distribution of the feedstock of FIG. 6 clearly indicating the super fine size distribution. The distribution is steep, having a D 100 of 6 μm, where D 100 means that approximately 100% by weight of the particles are under 6 microns in diameter.

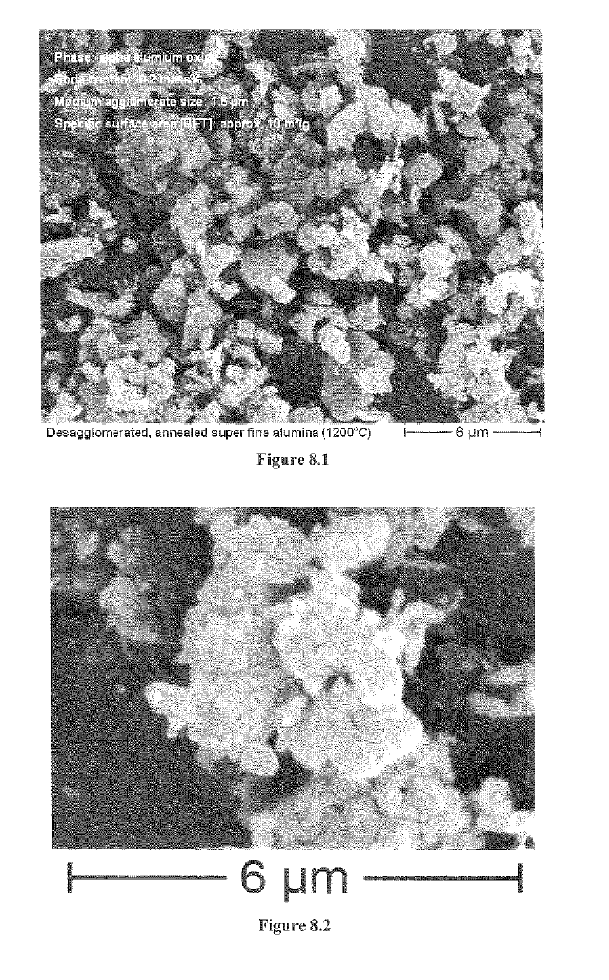

FIGS. 8.1 and 8.2 depict SEM data are taken by a JEOL 6400, Voltage is from 10 to 25 kV depending on the fineness of the powder, with finer powder requiring higher voltage, (support: polyether sponge PPI80, average pore size 0.3 mm). The desagglomerated, jet-milled thermally treated polishing alumina of the alpha alumina phase has primary aggregates, which are sized as the finely precipitated feedstock aluminum trihydroxide (FIG. 6). Inside the aggregates are nano-sized primary particles arranged with an average primary grain size of 200 to 300 nm (FIG. 8.2). Aggregates are the initial particles of the feedstock. The primary particles inside the aggregates are formed by thermal transition to alpha alumina. The lower the transition temperature to alpha alumina, the smaller the primary particles. At high temperature the limiting case would be, the size of the up-grown primary particle is equal to the size of the aggregate. During polishing, the aggregates may break up, increasing the polishing intensity. However, if the intention is to get an annealed powder with a smaller aggregate size, a finer feedstock or intensified milling is required.

Note that the aggregate size is almost identical with the particle size distribution of the feedstock hydroxide Martinal OL-107 LEO. Approximately 100% of the particles are smaller than 6 micron as measured by laser granulometer Cilas 1064. The particulate product has been produced by an aqueous suspension with a solid content of 72 wt %. This high solid content required a dispersing agent, in this specific case a synthetic polyelectrolyte Dolapix PC-21 from Zschimmer & Schwarz at a concentration of 0.25 weight %. A polyether sponge of the pore size 1/10 inch (PPI 10) was used. The sponge was inserted in a fire refractory saggar. The heating rate for annealing was 100° C. per hour. The retention time at the maximum temperature of 1200° C. was 5 hours.

Acids can also be deployed as dispersant and surface modifying additives in the initial stage by preparation of the feedstock slurry at room temperature or moderately higher. The presence of acidic aqueous suspensions prior to calcination, for instance the use of a 20 wt % acetic acid as the sole liquid, has an impact on the surface properties of the resulting alpha alumina by the formation of aluminum acetate in the aqueous phase. With high-thermal treatment at above 1000° C., nano-scaled alpha alumina particles from aluminum acetate are formed particularly on the surface of the aggregate. The shell-like surface of the post-calcined product gives improved surface removal.

FIG. 9 depicts the grain size of the post-desagglomeration product alpha alumina product prepared from the particulate of FIGS. 6 and 7. Upon comparison of the grain size distributions of the feedstock hydrate (FIG. 7) and the corresponding annealed alpha alumina (FIG. 9) after desagglomeration in a jet-mill, nearly identical distributions can be observed. The distribution of the annealed product may be somewhat finer due to the fact of volume shrinkage to phase transformation from aluminum trihydroxide to alpha alumina.

The described method is also applied for the manufacture of alpha alumina with defined grain sizes visually from 5 to 15 μm in diameter. FIG. 10 is a scanning electron micrograph of particulate prepared according to the present inventive method with the addition of 0.5 wt % NaBF₄.

The resulting platy lapping alumina with a BET surface area of 0.7 m²/g was annealed in an electric stationary furnace. Annealing simply refers to the thermal treatment, during which the particulate compound undergoes calcination. Calcination describes the change which is occurring with the product. The particles exhibit sharp edges to further promote the “removal” ability of the particulate while it is being used as a slurry-based lapping agent. The alpha alumina is formed from Martinal OL-107 LEO feedstock with the addition of 0.4 wt % NaBF₄ to the alumina (Martinal) feedstock. An aqueous slurry having 72 wt % solid content was restrained in a saggar and supported on a porous support (polyether 10 pores per inch) and was directly placed in the kiln at 1200° C. for 2 hours. NaBF₄ was observed to promote and control the growth of the primary crystals. In this example, the alumina particulate is being grown from a Martinal feedstock particulate, and NaBF₄ is used to promote the formation of sharp edges during the particle formation and calcination temperature ramp. Over-sizing of particles is prevented by use of a super fine feedstock, which limits excessive crystal growth. Desagglomeration is easily done by jet or pin milling. The primary articles have an average aspect ratio (shape factor) of greater than 3. By aspect ratio is meant the length of the long axis of the grain divided by the height of the short axis of the grain. Thus, the aspect ratio is a particle property which can be controlled by additives such as NaBF₄, which are present during particle formation.

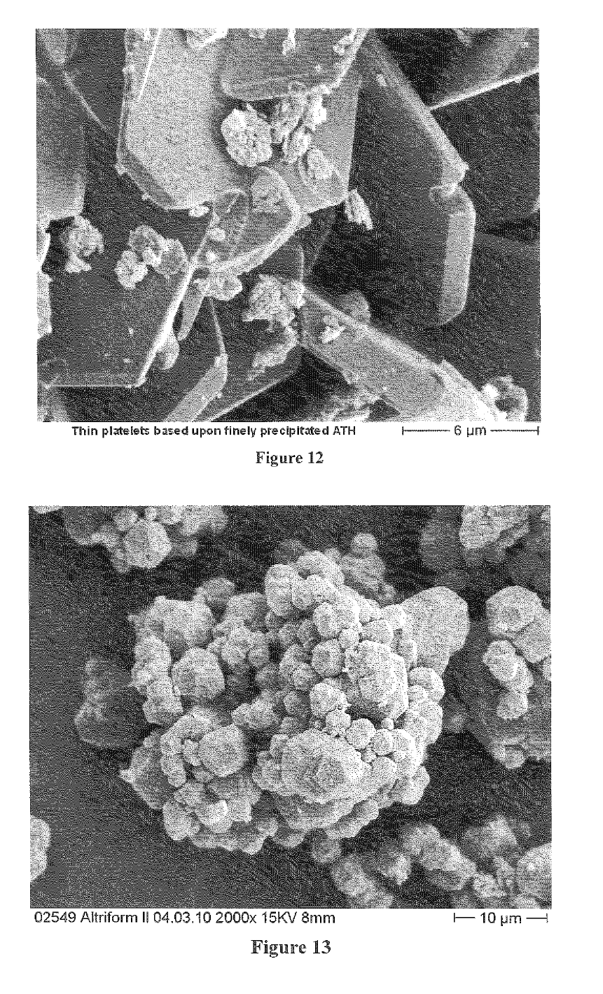

As indicated by the following trials and pictures, the aspect ratio varies depending upon the additive used. The comparison of FIG. 10 and FIG. 12 shows a difference in the effect of fluoride containing additives and their effect on grain growth and morphology. FIG. 10, which illustrates the use of NaBF₄—exhibits a more compact platelet-shaped particle, whereas FIG. 12 which illustrates the use of Na₂PO₃F—demonstrates a large platelet. Control of crystal growth can be achieved by the content of the mineralizer additive, the temperature, and the temperature ramp. When evaporable additives are used, it is generally recommended to run through a slow up-heating period, in order to avoid losing the mineralizer due to volatilization at low temperature. Combination of mineralizers or the use of multi-component salts can be chosen in order to design specific grains of size, shape, hardness and toughness. For instance, a fluorine concentration of greater than 0.1 wt %, respectively above the threshold, will be effective and almost optimal. Fluorine concentrations above 1 wt % are considered to be very corrosive for the equipment and to be chemically counterproductive for the final product.

Heretofore, it has been necessary to prepare lapping powders by separating particulate (prepared by existing methods) into defined fractions, as the preparation of a particulate having precise desired size characteristics was generally difficult. With the present invention, it is possible to control the size distribution of a particulate by controlling the feedstock size. The preparation of finely sized particles, particularly alumina particles as a highly desagglomerated powder with desired particle size and shape properties is demonstrated.

Similarly to the product of FIG. 10, FIG. 11 depicts particulate prepared according to the present inventive method with the addition of 0.4 wt % AlF₃, a two-component salt, instead of NaBF₄, a three-component salt. The annealing conditions were the same as in the preceding example employing NaBF₄, (support: polyether sponge PPI80, average pore size 0.3 mm) The resulting particles (platelets) are blockier, more rounded shaped and of greater thickness. Such a characteristic gives the particulate greater suitability for use in filler applications such as, for example, plastic fillers, because the crystal shape generally causes the associated particulate to have reduced abrasiveness. Injection equipment can be damaged by abrasion. Furthermore, rounded coarse particles lead to a higher filling degree of the plastic compound and platy shaped particles promote a higher heat transfer by contact of the large platy surfaces. The particle size of the depicted particulate was generally between 2 to 6 μm and the thickness of the primary crystal varies from about 1 to 1.5 μm. The BET surface area was measured to be 0.7 m²/g. Excessive crystal growth was not observed. AlF₃ acts as a crystal growth promoter, i.e., bigger crystals grow at the expense of smaller ones. However, in comparison to NaBF₄, the effect of AlF₃ limits the formation of the relatively large planes. The resulting product is easily desagglomerated. The post-desagglomeration particles exhibit an average aspect ratio of greater 2.

FIG. 12 depicts particulate produced according to the method of the present invention from particulate feedstock OL-107 LEO treated with 2 wt % Na₂PO₃F (support: polyether sponge PPI80, average pore size 0.3 mm). Similarly to the aforementioned fluoride-controlled examples, finely precipitated feedstock OL-107 LEO was treated with 1.5 wt % Na₂PO₃F under the same conditions as in the example immediately above, resulting in a thinly platy shaped crystal with a diameter of around 15 μm and a thickness of approx. 1 μm. The BET surface area is measured to be 1.5 m²/g. Because of its platelet form with highly reflective surfaces, such a product particulate can be used as a carrier for pigments or as a filler in coatings. The aspect ratio is generally greater than 10.

FIG. 13 depicts particulate formed according to the inventive method from an unseeded aluminum formate solution. The aluminum formate solution (5 wt % of Al₂O₃; aluminum formate equivalent to resulting 5 wt % Al₂O₃) has been thermally treated at 1200° C. (heating rate 330° K per hour and retention time at maximum temperature for 2 hours) by use of the present sponge method (polyether sponge PPI80, average pore size 0.3 mm). As a result, aggregates are formed having around 5 to 10 μm with smallest sized primary crystals at a size of a few hundred nm The BET surface area is 8.3 m²/g (Gemini VI).

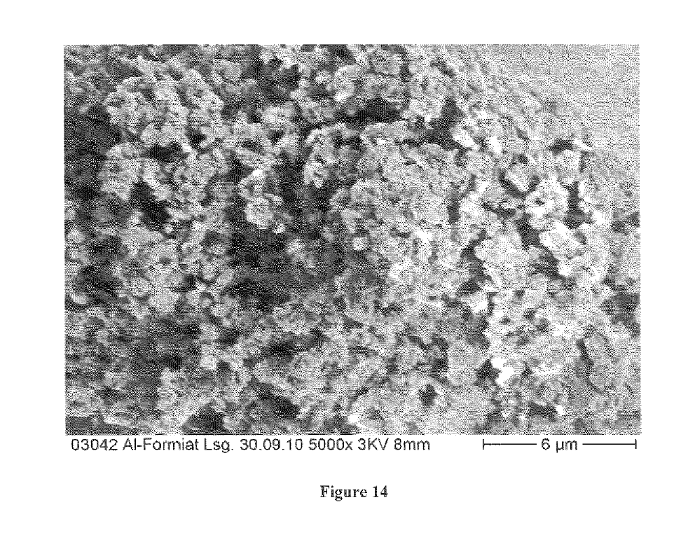

FIG. 14 depicts particulate formed according to the present invention from Aluminum diformate solution (10 wt % of Al₂O₃) with addition of alpha alumina seed particulate. 100 g Aluminum diformate solution (10 wt % of Al₂O₃, aluminum formate equivalent to resulting 10 wt % Al₂O₃) with addition of 2 g alpha alumina seeds was thermally treated at 1100° C. (heating rate 330° K per hour and retention time at maximum temperature for 2 hours) by use of the present porous support method (polyether sponge, PPI10, average pore size 2.5 mm). The resulting agglomerated alpha alumina contained aggregates of around 2 μm with smallest sized primary crystals at a size of around 400 nm inside the aggregates. The BET surface is 6.2 m²/g (Gemini VI). The alpha alumina seeds promote primary crystal growth. The XRD (x-ray diffraction) pattern clearly indicates that the particles contain the corundum phase alumina. This method of alumina preparation by liquid precursors can be used to synthesize fairly pure aluminas. The material can be used for polishing, and after desagglomeration (average particulate diameter <0.3 μm) the particulate can be used as a feedstock for performance ceramics.

The present inventive method is generally useful for the preparation of alpha alumina particulate as well as other particulate or agglomerated mineral compounds. Pure aluminum oxide (in some embodiments, pure alpha alumina, in other embodiments, a mix of alumina phases) can be made from alumina precursors or aluminum salts in presence or absence of seed materials, such as, for example, submicron alpha alumina particulate. For instance, chemical precursors in the alumina temperature phase sequence, which such as, for example, gibbsite, bayerite, amorphous aluminum trihydroxide, diaspore, precipitated boehmite, (re)crystallized hydrothermal boehmite, colloidal boehmite, pseudo boehmite, χ-alumina, η-alumina, γ-alumina, δ-alumina, κ-alumina, θ-alumina, α-Al₂O₃; or aluminum salts, such as, for example, aluminum chloride hexahydrate, ammonium alum, aluminum formate, aluminum acetate, aluminum nitrate, and the like, and can be deployed for the preparation of superfine, submicron particles.

While the purity of the feedstock is of importance in that specific applications may require relatively high purity product, it should be apparent that the ability of the particulate to undergo the requisite phase changes is generally not greatly impaired by the presence of impurities. Depending on the feedstock, the material's chemical purity—measured as wt % Al₂O₃—might be at 99,999 wt %. Final calcined alumina products ranging at 99.5 w. % Al₂O₃ are also suitable. Common impurities are Na₂O (<0.4%), SiO₂ (<0.1%), CaO (<0.1%), Fe₂O₃ (<0.1%). Products made by the presence of additives, such as, for example, one or more mineralizers/calcination additives might be slightly contaminated by the additive(s).

### Alpha Alumina Phase Products

Alumina precursor dispersions which are thermally treated in porous supports at temperatures greater than about 1000° C., will generally result in alpha alumina which can be desagglomerated to sub-micron powders suitable for specific polishing and performance ceramic applications. Said products, depending on purity, primary crystallite size, and grain size distribution can be useful in applications including the synthesis of sapphire and other types of corundum, engineering ceramics, bio-ceramics, translucent ceramics, hi-performance polishing, and as carrier and encapsulant for phosphorus salts and rare-earth compounds, and the like.

While the method can provide alpha alumina of high purity (for example, in excess of an alpha phase purity of 50 to 100 wt % and a chemical purity of upwards of 99.999 w. % Al₂O₃), the present invention is not limited to the production of high purity phase alpha alumina, and can be used to prepare alpha alumina particulate of relatively lesser phase purities (for example, as low as or even less than 20 wt % alpha alumina). Such lesser purity aluminas include alpha alumina having calcination of a lower degree.

Such lesser-phase-impurity-containing, incompletely-calcined aluminas can also function in the transition sequence of alumina being transformed to an alpha alumina of higher calcination degree by the process of the above invention, which can be promoted by mineralizers and increase of temperature. For example an amount of fluoride compound can be added to a high solid content suspension of incompletely calcined alumina to promote the transition to alpha alumina.

Transition alumina types which can be used in the present invention include gamma-phase, eta-phase, other non-alpha phases gibbsite, bayerite, nordstrandite, amorphous aluminum trihydroxide, boehmite, hydrothermal boehmite, pseudo boehmite, diaspore, and even alpha alumina phase. Alumina hydrates, transition alumina formed by loss of water, and aluminas that can be obtained by the thermal decomposition of aluminum hydroxides and oxyhydroxides. In general, compounds which are able, directly or through formation of one or more intermediates, to undergo or partially undergo the transition to alpha alumina at elevated temperatures can be used as precursors in the present invention. Aside aluminum trihydroxide some relatively common alumina compounds include, aluminum oxide hydroxide, pseudo boehmite, precipitated boehmite, colloidal boehmite, hydrothermal boehmite, amorphous boehmite, crystalline boehmite, diaspore and the like.

Particulate alumina compound types, particularly of alumina hydroxide, but of other forms including, but not limited to aluminum oxide hydroxides and oxides, which can be used as precursors, include colloidal, precipitated, hydrothermal, “finely precipitated,” amorphous; mechanically separated, such as granulated, ground, milled, “super-ground”; formed by sonication, vibration, and the like. In general, with respect to the particle formation embodiment, alpha alumina seeds can promote of the alpha alumina transition of deposits on the seed particulate by lowering the phase transition temperature.

Even alpha phase alumina which is lower in the thermal sequence and possibly lower in alpha phase degree than the resulting products, or alpha aluminas as reactants for aimed-at mineral compounds or aimed-at phase equilibrium, can be used as feedstock. See Examples 33, 39, 41 and 44.

Non-limiting examples of commercially available feedstocks include Martinal™ OL-1 11 LE, Martinal™ OL-104 LEO, Martinal™ OL-107 LEO, Martigloss™, Martifin™ OL-005, Martinal OS, Geloxal™ 10, BK Giulini aluminum formate solution, Sigma Aldrich ammonium aluminum sulfate dodecahydrate, Apyral™ 40CD, Apyral™ AOH, Sasol Disperal™ P2, Martoxid™ AN/I-406, Martoxid™ MR-70, Martoxid™ MR-42, Martoxid™ PN-202, RTA P172SB, Almatis CT-3000 SG, Almatis CL370.

In general, compounds which are able, directly or through one or more intermediates, to undergo or partially undergo the transition to alpha alumina at elevated temperatures can be used as precursors in the present invention.

### Non-Alpha Alumina Phase Products

The present inventive method can also be used to prepare particulate or agglomerated alumina phases having lower transition temperatures than alpha alumina, such as gamma alumina group, delta alumina group and others. Precursors can be selected from aluminum salts, aluminum containing precursors, aluminum hydroxide phases, and form thermally higher formed phases as precipitated boehmite, (re)crystallized hydrothermal boehmite, colloidal boehmite, pseudo boehmite of high purity, diaspore, gamma phase, delta phase, Other phases which can be created, or which can serve as precursors are χ-alumina, η-alumina, κ-alumina, θ-alumina. In general, it is difficult to achieve absolutely “phase-pure” compounds with eta and theta phase alumina precursors.

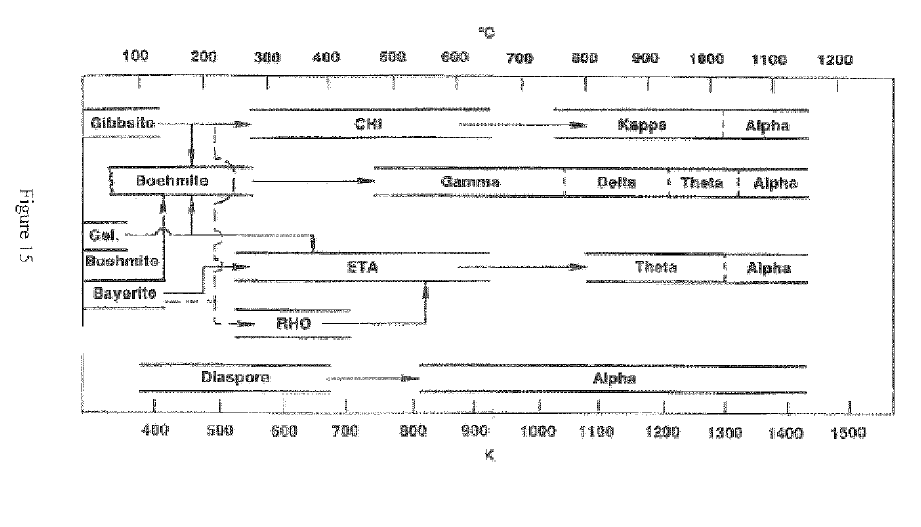

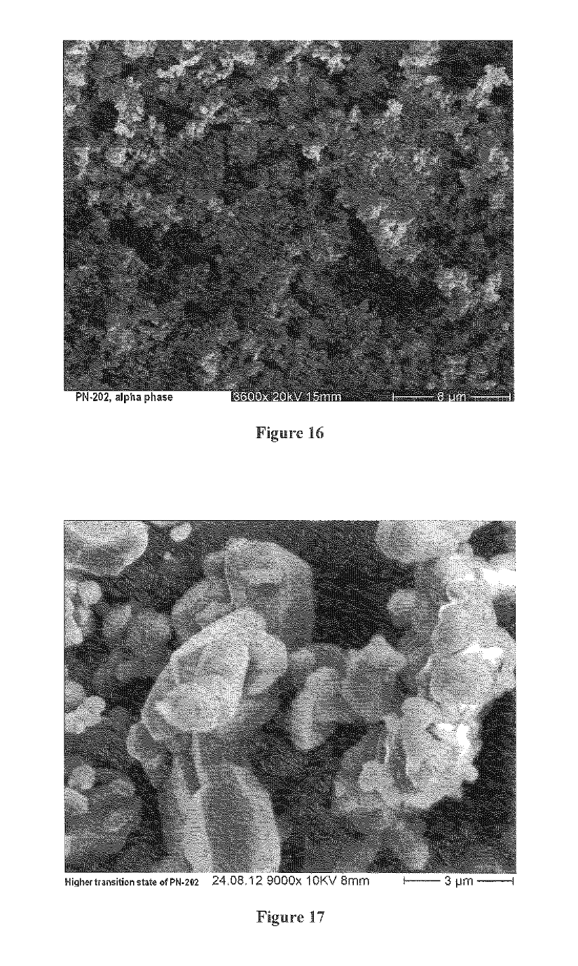

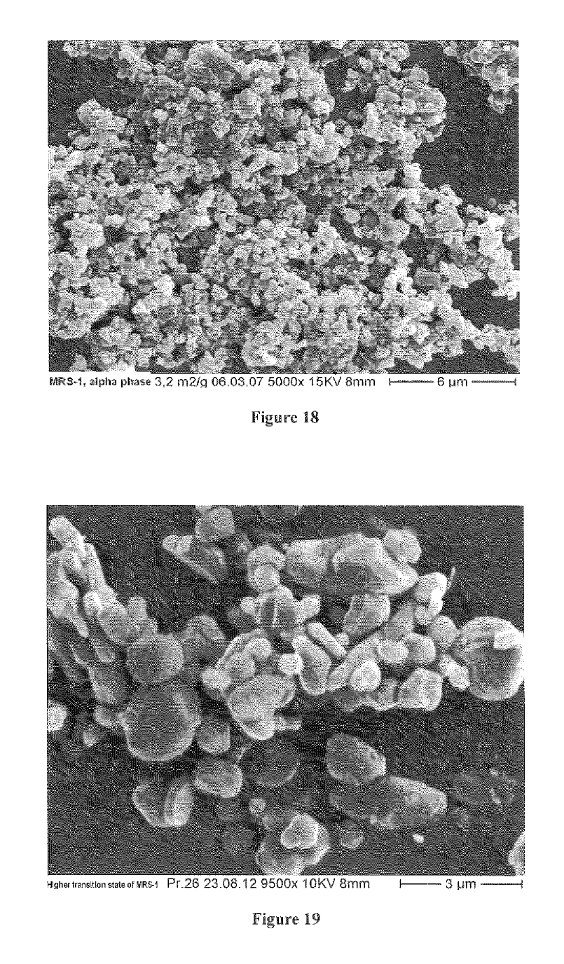

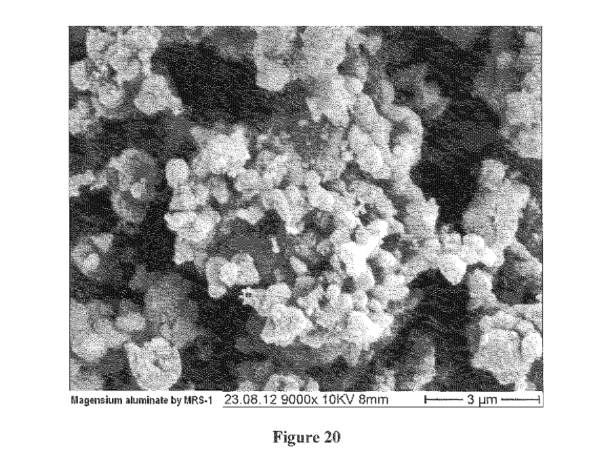

Useful as precursors in the present inventive method are particulate transition alumina compounds capable of transitioning to alpha alumina, such as, for example, upon heating to elevated temperatures such as alpha transition temperatures, which are generally above 1000° C. FIG. 15 illustrates the thermal hierarchy of alumina with phase transition temperatures and temperature ranges. As can be seen from the chart, depending on the thermal treatment, an activated alumina results according to the dehydration sequence of alumina hydrates in air. (Walter H. Gitzen, 1970, p. 17, The American Ceramic Society, ISBN: 0-916094-46-4).

The present inventive process can be applied to the preparation of lower temperature alumina phases, for example, intermediate alumina phases such as gamma alumina, which has a transition temperature high enough to cause combustion of the support. Thus, the preparation of agglomerate or particulate according to the present inventive method does not, in this case, require heating to alpha transition temperatures in all embodiments. For example, Gibbsite as a feedstock generally undergoes the transition to boehmite at around 250° C. and further transforms to gamma alumina at temperatures around 500° C. Transition aluminas such as chi alumina can transform to kappa alumina at 700° C. Low transformation phases of the transformation sequence of alumina can be useful for catalytic and other applications. For example, boehmite can be used as a catalyst and adsorbent in the hydrogen peroxide process. Gamma alumina can be used as a hydrotreating catalyst.

Examples of alumina-type precursors which can be used to form alpha alumina particulates include aluminum trihydroxides, aluminum oxide hydroxide and aluminum oxides, and other alumina or aluminum compounds, which either can undergo an alpha transition at alpha transition temperatures, or form compounds, either directly or indirectly, which, upon being subjected to alpha transition temperatures or a temperature ramp thereto, can undergo an alpha transition. Preferred is what is commonly known as “transition alumina” compounds. In other embodiments, particulate comprising a mixture of more than one of such compounds can be used, either comprising a mixed composition per particle, or comprising a mixture of particles each comprising one of said compounds.

Typical feedstocks and precursors include aluminum trihydroxide phases such as, for example, gibhsite, bayerite, nordstrandite, amorphous ATH; transition alumina phases, include crystalline boehmite, colloidal boehmite, gelatinous boehmite, pseudo boehmite, diaspore, and other sub-alpha alumina phases such as chi, kappa, eta, gamma, delta, theta, and the like.

The final “transitioned” product is affected by the feedstock-quality (initial particle, initial aggregate size, porosity, i.e., specific surface area [BET]). The use of reactive ultra-fine feedstocks influences and improves the powder's chemical and sintering reactivity. A high degree of dispersity and uniform distribution of the feedstock particles within the suspension contribute in the homogeneity of the final product.

If alpha alumina feedstock is adulterated with sub-alpha alumina feedstock or vice versa, the phase purity, crystal size and crystal shape of the resulting product is affected. A thermal treatment above the threshold of the alpha transition will give alpha transformation of the sub-alpha phase and, possibly, further reaction of the already existing alpha phase. The adulteration of the alpha alumina containing feedstock can be in the range of 2 wt % to 98 wt % of alpha phase and conversely of 2 wt % to 98 wt % sub-alpha phase.

It is also possible to transfer phase-pure alpha alumina in a product of greater grain size by accretive crystallization. See Examples 32 and 33. With addition of AlF3 and NaBF4 alpha alumina is used as feedstock for higher progressed transition. Examples 24 and 25 are directed toward the formation of magnesium aluminate (spinel) by using alpha phase alumina MRS-1 as the feedstock aside magnesium dihydroxide. The thermal reaction product spinel is finer than the higher alpha transitioned alumina of Example 33.

### Mineral Products, Both Aluminum-Containing and Aluminum-Free

In some embodiments, systems having more than one granulated component are slurried together and heated to give a granulated or agglomerated mineral product. The relative molar amounts of the component particulates of the slurry are proportioned stoichiometrically such that the crystal requirements of the target mineral are met. By this method, the present invention can be used to prepare aluminum-containing mineral products from mixtures of alumina and non-alumina precursors. Particulate ceramic spinel pigments, such as, for example, cobalt blue—also called cobalt aluminate or blue spinel, can be easily made from precursors including aluminum trihydroxide. Suspending stoichiometric ratios of a cobalt-compound and an alumina precursor particulate and firing at high temperatures, such as, for example, 1200° C. can lead to the formation of synthetic spinel. It is thus possible to manufacture the different colored spinel types and their solid solutions, such as, for example, chromite, FeCr₂O₄ (yellowish color), Zn(Fe, Cr, Al)₂O₄, (brown color—Al content promotes a lighter color) and other members, for instance of the formula (Mg,Mn,Fe²⁺)(Al,Fe³⁺)₂O₄. The present inventive process can be used to prepare other spinel types such as MgAl₂O₃, pleonaste (Mg,Fe²⁺)(Al,Fe³⁺)₂O₄, picotite (Mg,Fe²⁺)(Al,Cr,Fe³⁺)₂O₄, and their solid solutions, or mineral compounds and their solid solutions different from the spinel structure, such as aluminum titanate, cordierite (Mg,Fe²⁺)₂(Al₂Si)^{[4]}[Al₂Si₄O₁₈] and its derivatives. Garnets are nesosilicates with a wide range of compositions. They are generally described by the formula X₃Y₂(SiO₄)₃. The crystal lattice is built by an octahedral/tetrahedral framework with [SiO₄]⁴⁻occupying the tetrahedra. The X site is typically occupied by divalent cations (Ca²⁺, Mg²⁺, Fe²⁺) and the Y site is taken by trivalent cations (Al³⁺, Fe³⁺, Cr³⁻). Synthetic garnets have been developed for industrial applications. The Si-atoms can be substituted by Ge, Ga, Nd, Al, V, and Fe. Yttrium aluminum garnet (YAG) has the formula Y₃Al₂(AlO4)₃.Nd³⁺-doped YAG is a sophisticated material for laser application. Other examples of such mineral products include mullite, alumino silicates, aluminum containing oxidic minerals and the like.

In general, it should be noted that while embodiments of the present invention pertain to the formation of alpha and other phases of alumina via heat transformation from one alumina phase to another, other embodiments of the invention, such as the production of spinels from binary systems, involve transitions which are not alumina transitions, such as for example, the transition to spinel structure from a binary system, effected by heating to high temperatures.

For systems comprising two components, preferred aluminum components include alumina compounds such as, for example, gibbsite (Martinal™ OL-104 LE, Martinal™ OL-111 LE, Martina™ ON, Martinal™ OS, Martigloss™ 005), amorphous aluminum trihydroxide Geloxal™ 10, industrial manufactured trihydroxides, and the like; hydrothermal boehmite, colloidal hydrothermal boehmite, crystalline boehmite from thermal treatment, flash calcined pseudo boehmite from aluminum hydroxide, precipitated pseudo boehmite from aluminum metal as by the Al-isopropoxide route, ammonium alum, aluminum salts as aluminum nitrate, aluminum chloride hexahydrate, aluminum polyhydrate, aluminum formate and the like. Preferred non-alumina co-components include LiHCO₃, Na₂O, Mg(OH)₂, CaCO₃, SrCO₃, B₂O₃, SiO₂, H₃PO₄, TiO₂, Cr₂O₃, MnO, FeO, Fe₂O₃, Co(II)SO₄.7H₂O, Ni(II)SO₄.7H₂O, Cu(NO₃)₂, Zn(II)SO₄.7H₂O, ZrO₂, cerium acetate, and the like, preferably added as a salt, amorphous, colloidal or powdery material. While it is preferred that a homogeneous, i.e. highly dispersed, slurry be used, it is not absolutely necessary.

Maximum temperatures required generally fall in the range of from about 600 to about 1350 C and even higher, for times in the range of from about 10 min to about 100 hours. In general, times in the range of from about 1 to about 5 hours are more commonly used. As with the preparation of alumina, a temperature ramp from a lower temperature, such as, for example room temperature, can be used. The ramp rate profile can be at one or more rates in the range of from about 10 to about 1500 degrees per hour.

In general, mineral products which can be prepared according to the method of the present invention include cobalt aluminate, magnesium aluminate, spinels as zinc aluminate, chromite, magnesiochromite, titanate, others, and liquidus. Examples of pairs of components which can be used include Co(II)SO₄ and Al(OH)₃ (Martinal™ OL-111 LE); Co(II)SO₄ and Al(OH)₃ (Martinal™ OL-111 LE); TiO₂ (Kronos™ 1001) and AlOOH (Apyral™ AOH 20); Co(II)SO₄ and Zn(II)SO₄, and Al(OH)₃ (Martinal™ OL-104 LEO); Mg(OH)₂ (Magnifin™ H10) and Al(OH)₃ (Martinal™ OL-104 LEO; MgCO₃ and Cr₂O₃, Al(OH)₃ (Martinal™ OL-111 LE); alpha FeOOH and Zn(II)SO₄, and Al(OH)₃ (Martigloss™ -005); Co(II)SO₄ and Cu(NO₃)₂, and AlOOH (Sasol Disperal P2); submicronized quartz powder (Sikron™) and Mg(OH)₂ Magnifm™ H10 and FeCl₂, and alpha Al₂O₃ (Martoxid MR-70); and the like.

The present invention can also be used to prepare non-aluminum-containing mineral products upon ultra-fine sized powders and/or the corresponding feedstock salts. Single component products as sintered MgO (periclase), ZrO₂ (zirconium dioxide, zirconia) in the unstabilized, chemically partially and fully stabilized form. The cubic modification is commonly stabilized by some mole % of MgO, CaO, Y₂O₃, and even other dopands such as CeO₂, ScO₃, and YbO₃. Examples of more complex solid solutions deriving from non-aluminum-containing precursors are mineral products including spinel type minerals such as chromite (FeO.Al₂O₃), magnesiochromite (MgO.Cr₂O₃), LiMn spinel (LiMn₂O₄) or as [A²⁺B₂³⁺O₄²⁻] Co,Zn(Ti,Cr)₂O₄, for example Co_{0.46}Zn_{0.55}(Ti_{0.064}Cr_{0.91})₂O₄; the neso silicate Zircon Zr[SiO₄] functioning as colored pigments ZrSiO₄—Pr, ZrSiO₄—V, ZrSiO₄—Fe, for instance Zircon-Vanadium-Blue ZrSiO₄—V made from the components ZrO₂, SiO₂, ammonium metavanadate and NaF. Other examples include yttrium iron garnet (Y₃Fe₂(FeO₄)₃), gadolinum gallium garnet (Gd₃Ga(GaO₄)₃), barium titanate (BaTiO₃), yttrium aluminum perovskte (YAlO₃), which are products for high performance applications in the area of electronics. Other complex compounds of oxides and silicates and their solid solutions of various crystal types, present in the spinel type, perovskite type, pseudo brookite type, and the like, can be formed in the withdrawal of the present invention. Table 1 gives a list of examples of exemplary compounds which can be formed using the method of the present invention.

TABLE 1

| Aluminium containing | | |
|---|---|---|
| compounds | Formula | |
| Aluminium-containing | | |
| spinel | | |
| Mg aluminate | MgO•Al₂O₃ | stochiometric |
| Cobalt blue | CoO•Al₂O₃ | stochiometric |
| Iron aluminate | FeO•Al₂O₃ | stochiometric |
| Solid solution, pigment | [A²⁺B₂³⁺O₄²⁻] | |
| | Zn(Fe, Cr, Al)₂O₄ | cations variable |
| Pleonaste | (Mg, Fe²⁺)(Al, Fe³⁺)₂O₄ | cations variable |
| | (Mg, Mn, Fe²⁺)(Al, Fe³⁺)₂O₄ | cations variable |
| Picotite | (Mg, Fe²⁺)(Al, Cr, Fe³⁺)₂O₄ | cations variable |
| Non-spinel phase | | |
| minerals | | |
| Aluminium titanate | Al₂O₃•TiO₂ | Stabilizers: Si⁴⁺, Mg²⁺, |
| | | Ca²⁺ |
| Cordierite | (Mg, Fe²⁺)₂(Al₂Si)^{[4]}[Al₂Si₄O₁₈] | |
| Garnet | X₃Y₂(SiO₄)₃ | X: substitution partially |
| | | Ca²⁺, Mg²⁺, Fe²⁺; |
| | | Y: substitution partially |
| | | Al³⁺, Fe³⁺, Cr³⁺ |
| | | Dopands: |
| | | Ge, Ga, Nd, Al, V, Fe |
| Yttrium aluminum | Y₃Al₂(AlO4)₃ | Also Nd³⁺-doped form |
| garnet, YAG | | |
| Yttrium aluminum | YAlO₃ | |
| perovskite, YAP | | |
| Mullite | Al₂Al₂₋₂ₓSi₂₋₂ₓO₁₀₋ₓ | |
| Other alumo silicates | Sillimanite | Fe³⁺, Cr³+, Mg²⁺, Ca²⁺, |
| | | Ti⁴⁺, etc. |
| | Kyanite, andalusite, etc. | Al₂SiO₅ |
| Non-aluminum | | |
| containing compounds | | |
| Periclase | MgO | |
| Zirconia | ZrO₂ | Unstabilized form; |
| | | partially and fully |
| | | stabilized form with |
| | | dopands such as MgO, |
| | | CaO, Y₂O₃ up to 8 mol |
| | | %; optionally dopands |
| | | such as CeO₂, ScO₃, |
| | | YbO₃ |
| Non-aluminum- | | |
| containing spinel | | |
| Chromite | FeO•Cr₂O₃ | stochiometric |
| Magnesiochromite | MgO•Cr₂O₃ | stochiometric |
| Li—Mn spinel | LiMn₂O₄ | cations variable |
| Solid solution | [A²⁺B₂³⁺O₄²⁻] | Co, Zn(Ti, Cr)₂O₄ as |
| | | Co_{0.46}Zn_{0.55}(Ti_{0.064}Cr_{0.91})₂O₄ |
| Non-spinel phase | | |
| minerals | | |
| Silicate pigments | Zr[SiO₄] | ZrSiO₄—Pr, ZrSiO₄—Fe; |
| | | ZrSiO₄—V made from |
| | | ZrO₂, SiO₂, NH₄VO₃, and |
| | | NaF |
| Other silicates | And solid solutions thereof | |
| Oxides | | |
| Rutile, anatase | TiO₂ | |
| Barium titanate | BaTiO₃ | |
| Lithium titanate | Li₂TiO₃ | |
| Magnesium titanates | MgTiO₃, Mg₂TiO₄, Mg₂TiO₅ | |
| Bismuth titanate | Bi₄Ti₃O₁₂ | |
| yttrium iron garnet, YIG | Y₃Fe₂(FeO₄)₃ | |
| gadolinum gallium | Gd₃Ga(GaO₄)₃ | |
| garnet, GGG | | |
| Other oxides | And solid solutions thereof | |

Spinel compounds with aluminum oxide as magnesium aluminate, cobalt aluminate, magnesiochromite, solid solutions of picotite or pleonaste, and the like; and Aluminum containing oxide compounds as aluminum titanate, yttrium aluminum garnet, yttrium aluminum perovskite, and the like; can be manufactured by precursors and components which are based upon the following:
Alumina in general, aluminum salts
Magnesium containing precursors as Mg-oxide, Mg-hydroxide, Mg-salts, MgCO₃ etc.
Metal precursors as salts and oxides containing cobalt, nickel, zinc, copper, palladium, silver, chromium, manganese, titanium, iron, boron, phosphorus, lithium, yttrium, lanthanum, cerium, neodymium, gadolinium, gallium, germanium, arsenic, barium, bismuth, lead, and the like.

Mineral compounds as silicates like cordierite (Mg,Fe²⁺)₂(Al₂Si)^{[4]}[Al₂Si₄O₁₈], sinter mullite, garnet X₃Y₂(SiO₄)₃, and the like could be synthezised by precursors including one or more of the following:
Alumina in general, aluminum salts
Metal containing precursors as salts, oxides of silicon, zirconium, cobalt, nickel, zinc, copper, palladium, silver, chromium, manganese, titanium, iron, boron, phosphorus, lithium, sodium, potassium, barium, strontium, magnesium, yttrium, lanthanum, cerium, neodymium, gadolinium, gallium, germanium, arsenic, barium, bismuth, lead, and the like.
Other feedstock compounds include silicates and metallic minerals such as, for example, chromite (FeCr₂O₄), spodumen (LiAl[Si₂O₆]), kaolin Al₂Si₂O₅(OH)₄ and the like.

Optional single compounds and co-compounds can be manufactured containing no aluminum oxide: periclase (MgO), rutile/anatase (TiO₂) zirconia (ZrO₂, even stabilized with MgO, CaO and/or Y₂O₃); Spinel compounds as chromite (FeCr₂O₃), LiMn spinel (LiMn₂O₄), and the like; Titanates as barium titanate (BaTiO₃), lithium titanate (Li₂TiO₃), magnesium titanates (MgTiO₃, Mg₂TiO₄, Mg₂TiO₅), bismuth titanate (Bi₄Ti₃O₁₂), and the like; Garnets as yttrium iron garnet (YIG), gadolium gallium garnet (GGG), and the like.

Further additives, such as, for example, stabilizers, among other things, can be used with the slurries used in the present invention. Many of the following are available from suppliers such as BTC, Coatex, Topchim, Zschimmer & Schwarz and the like:
dispersants: citric acid, polyacrylates, acrylic polymer, polycarboxylates, organic acids, maleic acid, xanthane, and other hydrosols;
co-components: organic and inorganic acids as formic acid, acetic acid, citric acid, nitric acid, hydrochloric acid, sulphuric acid, etc.; being present in the slurry and getting lost by the thermal process, albeit affecting the final product properties of the particulate;
rheology/viscosity affecting agents (rheology modifiers)/solid content increasing agents: citric acid, organic acids, polyacrylates, acrylic polymer, polycarboxylates, organic acids, maleic acid, xanthane, and other hydrosols, amorphous dispersible alumina, amorphous silica;
surface active substances and stabilizing agents, or pH and isoelectric point controlling additives: citric acid, hydrosols, polyacrylates, organic acids, ammonia, caustic soda, glycols, triethylamine, triethanolamine, gum arabic, polysaccharide, carboxylic acids, suphonic acids; antifoaming agents: 1-octanol, polyglycol, polyacrylates, tensides; organic gelling/thickening additives: cellulose, starch, gum arabic, amorphous dispersible alumina, amorphous silica, xanthane and other hydrosols; additives affecting friability of the transition product: oleic acid, polyglycols, fatty acids; preservatives and biocides used against bacteria formation: benzoates, sorbates, acetates, biocides as isothiazolines, bromonitropropanediol, also in combination with H₂O₂.

The particulate and higher-order structure products which can be prepared have applications as fine abrasives and polishing powders of uniform distribution without large particle size outliers, suitable for use as lapping powders, such as for silicon wafers; high-gloss polishing powders. The inventive method can be used to prepare both aluminum-containing and non-aluminum-containing spinel pigments and particulate compounds (particularly super-fine ceramic grade); flame retardants; engineering ceramics such as, for example, aluminum titanate; filler materials in polymer applications; and refrigerant core in cooling media maintenance applications.

### Non-Particulated Products

The present invention can be performed, without implementing a particulation step, to produce a product, i.e. in its agglomerated state. For example, when prepared from precursors including a binding phase, such as, for example, aluminum phosphate, amorphous aluminum trihydroxide, (re)hydrated alumina, pseudo boehmite, peptizable boehmite, amorphous silica, water glass, concrete, and inorganic gels such as bentonite and the like.

In other embodiments, the present invention can be performed, without implementing a particulation step, to produce a product, which is useful in its agglomerated state. For example, in some embodiments, the support is not lost completely to combustion, and functions as an adsorbent in applications such as water purification.

Generally, in such embodiments, binders such as, for example, peptizable boehmite, aluminum phosphate, amorphous aluminum trihydroxide, pseudo boehmite, (re)hydrated alumina, silsequioxane, amorphous silica, waterglass, cement, calcium aluminate, and inorganic gels such as bentonite and the like are included with the particulate precursors. The use as adsorbent or catalyst generally requires a thermal treatment at 400° C. and higher due to the fact that adsorptive activity of the product is important. At around 300° C., boehmite is formed, a mineral phase with a high specific surface area (BET) of greater than about 200 m²/g, and having good adsorptive properties.

The binder is generally included in the particulate in the form of a dispersion or super finely sized suspension (in some embodiments, the average grain size can be significantly less than about 5 μm). Hydraulic binders and particulate binders such as cement and calcium aluminate are customarily added as a coarser sized suspended material (in such embodiments, average grain size can be less than about 50 μm). The thermal treatment at maximum temperature should be at least for 30 min. The temperature should be in excess of 350° C. At temperatures of less than 500° C., the final product generally contains carbon remains of the polymeric support. In some embodiments, the binder may affect adsorption capacity.

The resulting agglomerate generally does not need to be desagglomerated in order to perform its absorptive function. However it might be desirable to perform a relatively gentle mechanical separation if the agglomerates stick together in patches. Such agglomerated product can be used as an adsorbent for water or other purification, or as a catalyst, for instance for the AO-process in the manufacture of H₂O₂.

With respect to non-particulated products, agglomerate size-affecting additives, such as binders, are preferably used. The binder is preferably present in the particulate precursor in an amount in the range of from about 2 wt % and preferably at least at 5 wt % up to about 100 wt % based upon the solid ingredients of the slurry. Preferably thermally stable, mineral phase based binders are used in order to obtain granules with good compression strength. Binders for agglomeration include aluminum phosphate, pseudo boehmite, hydrated alumina, amorphous silica, water glass, concrete, and inorganic gels as bentonite and the like. Dispersion/suspension stabilizing agents and particle-surface stabilizing agents which can be used include polyacrylates, polyethylene glycols, acetic acid, citric acid, oleic acid, amorphous silica, xanthane, and the like.

In general, with respect to both feedstock embodiments and particle formation embodiments, the connections between particles to form agglomerates are affected by the presence of binders. Inter-pore growth, i.e., that between granules, can be strengthened by the use of “strong” binder formulations, such as, which facilitate coarser granules, have to be crushed into the desired granule fractions afterwards.

However, the manufacture of granulates correlates with by the pore size distribution of the support and can be affected by the co-use of binders. By “binder”, we mean an additive that establishes interparticle connections during the temperature ramp. Binders are generally used to increase the size of the granular product of the process. Thus, in the case of the particle formation embodiment the use of a porous support in conjunction with a binder generally results in an agglomerated mass of around the pore size of the support, and within the interlinked pore system even in larger agglomerated units loosely bound into each other at pore transition region. These loosely bond agglomerates can easily be ground into granulates which correspond more or less with the pore size of the support. Examples of binders can generally include alumina phases such as pseudo boehmite, aluminum phosphate, waterglass, and the like.

Some of the examples herein show that by use of a porous support and the presence of a strong binding agent (pseudo boehmite), a strengthened granulated product will result. Polymeric supports of pore sizes of 10 to 80 PPI with mesh sizes are ideal to prepare granule sizes of 6 to 48 mesh (ASTM), which are in line with typical adsorptive and catalytic applications (Pore concentration of 80 ppi corresponds to particles of about 45 mesh, and 50 ppi corresponds to particles of about 35 mesh.)

### Particle Formation Embodiment

In an additional embodiment, included within the ambit of the present invention is the formation of particulate from a solution, dispersion or suspension. The particulate can be formed during the temperature ramp or during the application of calcination temperatures. In additional embodiments, the solution comprises a seed particulate. With or without a seed particulate, the solution comprises an alumina precursor such as, for example, aluminum formate or aluminum diformate, which is capable of forming alumina particulate. A broader list of alumina precursors which can be used include aluminum salts and their hydrates of inorganic and organic origin, such as, for example, aluminum formate, aluminum acetate, aluminum propylate, aluminum nitrate, polyaluminum chloride (PAC), aluminum sulfate, ammonium alum, aluminum chloride, aluminum chloride hexahydrate, and the like.

In one embodiment, the precipitation takes place prior to calcination temperatures, and the precipitated particulate partially or fully undergoes calcination when subjected to a temperature ramp to calcination temperatures. In another embodiment, the precipitation is aided by the presence of seed particulate, such as alpha alumina particulate. In some embodiments, the seed particulate in characterized by an average diameter of 50 to 1000 nm, preferably in the range of 100 to 400 nm. The solution or slurry is applied to the porous support and subjected to a temperature ramp. In general, a mass results which has a degree of annealing, frequently only loosely annealed, and generally can be relatively easily desagglomerated into particulate. Unlike the prior embodiment, the “particle formation” embodiment produces particulate which generally is not dependent upon a precursor for particle size properties. Instead, it is thought that the pore size properties of the open-celled support are influential with respect to the size of the agglomerate which forms while the solution, dispersion or slurry in which it is contained resides on and within the support.

In the case of solutions which are seeded, the properties of particulates prepared from solutions of aluminum formate, ammonium alum, and the like are controlled by the presence of a seeding material. Its grain size distribution, quantity of seed, purity, chemical and surface activity indicated by the alpha degree (alpha phase pureness), specific surface area, surface charge, degree of surface rehydration, and other characteristics. The annealing temperature, respectively the applied temperature profile has an impact on precipitation and transition as well. Seeding reduces the transition temperature of the alpha-formation and causes a moderate and controlled grain growth, if desired at primary crystal size much less than 1 μm. The smaller the seed and the higher the number of seeds, the smaller the product particulates, and the lower the transition temperature.

For particulation from unseeded solutions, in general, the matter of the solution (concentration, transition point to a solid alumina compound, and phase transition sequence to the desired alumina phase) and the thermal treatment of the applied process play a role in primary particle size formation of the final thermally treated product. Heterogeneous nucleation is also effective caused by the contact sites to the polymeric support and the burnt matter, which might also function as promoter for the formation of nuclei. Supports having smaller pore sizes promote nucleation more effectively than coarsely pored supports.

Alumina compounds can fulfill other functions in the context of the present invention besides or in addition to functioning as a feedstock or seed particle substrate. Pseudo boehmite or gelatinous aluminum hydroxide, for example, can function as a co-reactants, binding phases and/or dispersity controlling agents. For instance, amorphous and peptizable aluminum hydroxide and boehmite can be used as dispersants for slurry stabilisation, resulting in an improvement of the dispersibility of the alumina feedstock particles, as well as imparting an improved stabilization against settling. A relatively low weight percent (0.5 to 5 wt %) optionally in combination with traces of univalent mineral acid or formic acid or acetic acid (2 to 5 wt %) can affect gelling and the electrostatical stabilization of the slurry. Higher content of pseudo boehmite up to the saturation limit of the dispersion, for example, up to approximately 15 wt % can function as a binder to adhere the particles of the feedstock. At increasing temperature in accordance to the transition sequence the binder can undergo chemical transition and contribute physically and chemically to the performance of the final product. The resulting granulate might function in an adsorptive application (see Examples 42, 43 and 44), and at higher temperature (greater than about 1000° C.) the amorphous alumina can function as co-reactant in a ceramic reaction with other alumina phase(s) within the range of alpha transition as described by the Examples 16 to 19 and 22 to 30. The advantage of the use of the mentioned alumina co-components is species-specificity by causing no non-aluminum contamination of the resulting alumina product or alumina containing product.

It should be noted that while the particulate precursor comprises a non-alpha alumina content (or content of one or more compounds which can, as indicated above can either undergo an alpha alumina transition at alpha alumina temperatures or produce a compound, directly or indirectly, that can) or other transitionable materials, it is not necessary that the particulate be solely comprised of such compounds.

The particulate can comprise other compounds, such as, for example, co-components which affect the working conditions of the dispersion or slurry, such as for example the degree of dispersibility, grade of homogeneity of suspended particles, settling and wetting behavior of suspended particles in a suspension or a blend of suspended and dispersed components. Additives and co-components may affect the chemical and physical properties of the initial slurry and the final product. Co-components might undergo specific chemical reaction(s) in formation of solid solutions and other mineral phases.

At the initial stage of the process, co-components can function as dispersity-controlling agents, to accomplish high solid contents and to prevent sedimentation of the suspended particles. Upon the thermal treatment required in the present invention, certain co-components can function as partners, in order to promote specific reactions. They can affect the temperature of phase transition, degree of reaction, the surface area, the formation of specific particle shape in promoting a roundish or platy shaped particle, the grain's aspect ratio, friability, hardness, abrasiveness, the powder's chemical reactivity and purity, and the like.

For example, fluorides such as NaF, NaBF₄, KAlF₆, and the like can generally function as mineralizers by lowering the alpha phase transition temperature and promoting particle growth and change in shape. Fluorides primarily function as a promoter for the formation of platy-shaped particles. The particle width can grow as fast as or faster than twice as fast as the height dimension, such that flat particles are formed, as is demonstrated in Examples 7, 8 and 31-33. In comparison, boron additives promote the formation of rounded particles.

Magnesium compounds as Mg(OH)₂ or MgCO₃ can function as particle growth inhibitors. Without desiring to be bound by theory, it is surmised that the compounds act by partial or incomplete formation of spinel at the particle boundary.

Cobalt salts, iron salts, chromium salts and compounds may specifically be used in the formation of pigments, in particular in manufacture of spinel varieties as cobalt, CoAl₂O₄ aluminate (bluish color) including related solid solutions as Co(Al, Cr)₂O₄, (Zn, Co)(Cr, Al)₂O₄, (Co, Zn)Al₂O₄, chromite, FeCr₂O₄ (yellowish color), Zn(Fe, Cr, Al)₂O₄ (brown color—Al as substituent promotes a lighter color) and other members, for instance of the formula (Mg,Mn,Fe²⁺)(Al,Fe³⁺)₂O₄. Spinel varieties themselves can also function as reaction partners in phase equilibrium with cations different to the formula of the feedstock spinel by integration on the specific positions in the crystal lattice.

### Some Specific Mineralizers and Inorganic Additives

Mineralizers are used to influence the final properties of the product by impact during the calcination process. They are particle size and particle shape affecting substances.

In particular, fluorides promote crystal growth and modify the particle shape in comparison to product which have been calcined without a fluoride. Significant but less effect is caused by chlorides and boron oxide/acid/salts.

Growth promoters by effect of strength—more or less from greatest strength to less strength include:
platy shape-forming:

KBF₄, NaBF₄, BF₃, VO₃F, VF₃, VF₅, Na₃[AlF₆], KF, NaF, CaF₃, ZnF₂, TaF₅, AlF₃, Na₂PO₃F, etc.
round shape-forming:

boron oxide/acid/salts

Cl₂, NH₄Cl, AlCl₃

Mineralizers can also be used in combination. For instance NaBF₄ as one compound which thermally decomposes into NaF and BF₃, or the use of two or more CaF₃ and AlF₃ and/or B₂O₃. Fluoride has tendentially a dominating effect. On the other hand, boron tendentially promotes the additional roundness of the particle edges.

Mineralizers have different effects on the particulate product. Na₂PO₃F favors extremely thin platelets of great expansion. NaBF4 tendentially promotes the thickness of the primary crystal at relatively high stretch-out. In general, mineralizers can act to reduce the transition temperature is reduced, with the impact of fluorides generally greater than other mineralizers.

Other mineralizers have an influence on the final product and can be used for growth control and in hardening the particles. Substances include cobalt oxide, chromium oxide, ferric oxide, nickel oxide, copper oxide, magnesium oxide, calcium oxide, strontium oxide, sodium oxide, potassium oxide, zirconium oxide, yttrium oxide, titanium oxide, zinc oxide, manganese oxide, silicon oxide, boron oxide, phosphorus oxide, cerium oxides, lanthanum oxide, and the like. Good results have been realized with cerium oxide, giving small primary particles. It can be used in combination with NaBF₄ for shape promotion.

In ceramic applications inhibitors such as MgO, MgO.Al₂O₃, and Cr₂O₃ are used to control grain growth of the microstructure.

As already described, growth “seeds” affect the heterogeneous nucleation in controlling and in promoting the phase transition at lower temperature and at a higher rate to alpha alumina.

### The Support

The support useful in the present invention can include polymeric supports such as polymeric sponges or other porous polymeric materials having an “open-celled” structure. By “open-celled,” it is meant that many of the cells in the support are interconnected. Such a characteristic is required in order for the slurry which is applied to the support to penetrate the support. An “open-celled” support, for the purposes herein, is one in which the fluid connections are such that the dispersion, slurry or solution used can penetrate the recesses of the sponge. The open cell structure need not be 100% of the pore volume. In general, a greater degree of penetration is preferred to a lesser degree.

Non-limiting examples are polymeric supports, foams, sponges, cloth, sheets, or other porous, open-celled support made of polystyrene, polyethylene, polypropylene, polyurethane, polyether, polyester, polyethylene, terephthalate, nitrile butadiene rubber, biopolymers, polystyrene, polyamides, cellulose, starch, polysaccharide, and the like. In general, polymers which have greater wettability by the slurry fluid phase or the solution are easier to load, and more easily loaded to a greater degree. In a preferred embodiment, the open celled support is capable of being soaked through by the slurry or solution used. Generally, supports are commercially available within the range of 10 to 80 pores per inch (PPI). Good results have been achieved with polyether and polyurethane based filter-foams providing a porosity of 10 to 30 PPI at a low volumetric weight of around 15 to 30 kg/m³ and a good shape recovery. High volume weight, such as around 200 kg/m³ can be disadvantageous to cost, available space, and wetting properties. Preferably the compression strength at 40% compression (the pressure required to reduce volume by 40%) is about 5 kPa or lower, although those with higher compression strengths can be used as well. Polymeric supports which can be used include the following sponges: polyether sponge, PPI10, average pore size 2.5 mm; polyurethane sponge PPI40, average pore size 0.6 mm; polyurethane sponge PPI60, average pore size 0.4 mm; polyether sponge PPI60, average pore size 0.4 mm; polyurethane sponge PPI80, average pore size 0.3 mm; polyether sponge PPI80, average pore size 0.3 mm polyurethane sponge, ultra-fine, average pore size 0.15 mm.

In most embodiments, it is preferred that the support be lost to some degree, preferably to heat-mediated processes, such as, for example, combustion. In more preferred embodiments, the support is combustible at a low or minimal ash rate, such that the support is largely lost to combustion during the temperature ramp to calcination temperatures. In other embodiments, the process can be performed in an oxygen-free atmosphere, a reductive atmosphere or an inert gas atmosphere.

In other embodiments, the support is made in situ by simultaneous blending of polyol, isocyanate, and mineral components such that a shaped foam is formed. In further embodiments, it is shaped thereafter by extrusion to get a continuously formed feedstock of foam and mineral components.

In general, combustion of the support is completed at temperature range of 500 to 800° C., and ideally, the support has fully combusted prior to calcination temperatures. For some adsorptive or catalytic applications, remains of carbon—due incomplete combustion—could be advantageous. However, in general, products formed by transitions at a given temperature are formed on a support which has fully combusted (i.e., any remains are non-combustible) by the time the product is formed.

In other embodiments, the support does not combust or does not fully combust, or is prepared from non-combustible materials such as blocks of mineral wool, mats of glass fibres or mineral fibers, such as Insulfrax S blanket (Unifrax), laminate matt ML 3 (Isover), mineral wool matt MD 2 (Isover), which function as a reactant of the final compound, or in case of chemical inertness as a co-component within the final product. Ceramic, non-combustible, porous supports as fine strainer cores with cylindrical or rectangular channels (Vesuvius Group-Foseco, Rodex series) could also be applied as a carrier of catalytic and adsorptive media. Such a ceramic filter could function as well as a porous substrate. The reaction products can be leached, washed or otherwise separated from the substrate, such as by the use of ultra-sonic generator.

The slurry or particle-forming materials are applied to the support in such a manner that the interstices of the support are at least partially filled with the material. In the case of a slurry or other materials of sufficient viscosity, it can be desirable to apply the materials directly to the support, as the viscosity may be sufficient to keep the material in contact with the support, and the dispersion/slurry is partially or completely drawn in. It may be necessary to apply pressure to the slurry once it is on the support in order that it sufficiently enters the interstices of the porous support. Wetting and filling of the support can also be enhanced by vacuum and pre-conditioning of the support by hydrophilic agents. The dispersion/slurry can contain hydrophilic and surface tension reducing agents for the control of the rheological properties. The penetration of the support can be conducted in a manually or an automated manner.

The annealing process preferably is conducted in a closed, elevated temperature environment, such as, for example an electrically or gas heated kiln/furnace, which can be stationary or continuously operated. Examples include commonly used kilns such as roller kilns, a tunnel kilns, a hood furnaces, elevator furnaces, chamber furnace, and the like. In one embodiment, a polymeric support, preferably rectangular, is placed inside a rectangular case, such as a ceramic saggar made of thermally resistant materials like corundum, cordierite, silicon carbide and the like. In a further embodiment, a laterally enclosed support (sides and/or bottom could be liquid-proof coated or paperbacked by combustible matter such that the surfaces are not directly exposed to the heat) could be used.

Saggars made of refractory material, such as, for example, refractory corundum, can be used as container for the support. Other materials include silicon carbide, aluminum silicate (mullite, andalusite, etc.), cordierite, silica, graphite and the like as long as reactions with the lining are minimal An exemplary saggar is a rectangular-shaped hollow body with an open top. An exemplary saggar has the following dimensions: the external dimensions are (l) 0.225 m×(b) 0.162 m×(h) 0.153 m; wall thickness of is are around 0.013 m; the internal dimensions are (l) 0.2 m×(b) 0.134 m×(h) 0.132 m; and the maximally usable height is around 0.12 m.

Exemplary sponges which can be used as supports include those made of polyethylene and providing sufficient elasticity indicated by the parameter “compression load deflection” for maintaining their body shape and dimensions. Exemplary pore size ranges include the pore sizes from 2.5 mm (FIGS. 6 to 12) to 0.3 mm (FIGS. 13 and 14), which is equivalent to the specification of between 80 pores per inch and of 10 pores per inch (commonly abbreviated as PPI 80, PPI 10). Exemplary dimensions of the inserted sponge such as, for example, a sponge from the product line AIXPOR FILTREN are (l) 0.2 m×(b) 0.133 m×(h) 0.096 m corresponding to volume of approx. 2.5 1. The sponge can be fitted into the saggar such that it touches the inner surfaces of the saggar.

Suitable supports made from polyether have the following specifications:
(1) PPI 10, recticulated: pores per inch: 10 to 14 cells; volumetric weight: 22.5 to 27.5 kg/m³ (DIN EN ISO 845); compression load deflection: 3.2-4.8 kPa (DIN EN ISO 3386-1); tensile strength: 60-100 kPa (DIN EN ISO 1798); elongation at break: 40 to 60% (DIN EN ISO 1798); and
(2) PPI 60, recticulated: pores per inch: 55 to 70 cells; volumetric weight: 27 to 33 kg/m³ (DIN EN ISO 845); compression load deflection: 2-4 kPa (DIN EN ISO 3386-1); tensile strength: 220 kPa (DIN EN ISO 1798); elongation at break: 200% (DIN EN ISO 1798).

In other embodiments, the support does not combust or does not fully combust, or is prepared from non-combustible materials such mats of glass fibres or mineral fibres, which function a reactant of the final compound, or in case of chemical inertness as a co-component within the final product.

Regardless of the fact that the liquid phase of the slurry, which is preferably water, is generally lost quickly upon heating it has been observed that sedimentation is barely noticeable and the properties of the particles are surprisingly free of defects associated with uneven thermal conductivity, such as that present with the heating of dry particulate. Unexpected advantages, given the loss of the aqueous phase early in the process, include the lack of settling of the precursor during alpha alumina particulate formation and the increase in precursor thermal homogeneity during the temperature ramp, resulting in increased homogeneity of properties. It has also been found that additives can easily be employed in the above method in order to give particles having desired properties.

### Some Effect of Pore Size and Pore Size Distribution of Porous Support:

Polymeric supports, foams, sponges or other porous, open-celled support might be made of polystyrene, polyethylene, polypropylene, polyurethane, polyether, polyester, polyethylene terephthalate, nitrile butadiene rubber, biopolymers, and the like. Excellent soaking properties for suspensions have been achieved by filter foams providing coarse pores in the range of 10 to 20 PPI. Solutions and dispersions are easily up-taken up to 80 PPI. The pore size, and pore size distribution doesn't significantly affect the primary aggregate size of the calcined product, it corresponds with the initial aggregate size of the feedstock. However, the loose agglomeration of the bulk correlates with the pore size.

For example, in the case of a finely precipitated aluminum trihydroxide Martinal™ OL-107 LEO, aluminum oxide hydroxide Apyral™ AOH 20 or gamma alumina Martoxid™ AN/I-406, which has been treated at a temperature of 1200° C., the original particle size is maintained in the final product, which can be used as a polishing powder. Similarly, this particle structure of ultra-micronized aluminum trihydroxide and its thermal derivatives (in the transition sequence) is also maintained in use of cobalt sulfate in the thermal formation of a colored body called cobalt blue.

One example of a situation in which the present inventive method provides an improved method for production is in the manufacture of sol gel corundum. The sol-gel corundum has heretofore been largely produced from amorphous aluminum trihydroxide or aluminum oxide hydroxide. After an alpha alumina-seeded pseudo boehmite or alumina precursor is gelled, it is usually dried as a cake, subsequently crushed, screened, fired at the appropriate annealing temperature, and finally graded to the requested grain (for example U.S. Pat. No. 4,518,397). In comparison to sol gel, the present application provides easier handling and involves a one-step operation, only in continuous transition. The highly concentrated sol—unseeded or seeded—is poured on the porous support. By partial loss of water during the heating process, the gel is formed within the pores and cavities of the support. After thermal loss of the support and further calcination, a loose bulk of granules is obtained with specific properties deployed for use as a polishing, grinding agent, filler or sophisticated ceramic feedstock. Depending on the specific requirements, particle sizing might be conducted by additional screening and/or milling.

The precursors are applied to the porous support as a slurry. In an embodiment, the slurry comprises water, at least in a minor amount. In a preferred embodiment the slurry is an aqueous slurry. By “aqueous slurry” is meant a slurry comprising in the range of from about 10 wt % to about 95 wt % water. In a preferred embodiment, the slurry comprises in the range of from about 10 wt % to about 80 wt % water. In a more preferred embodiment, the slurry comprises in the range of from about 25 wt % to about 75 wt % water.

The alumina precursor is present in a wt % in the range of from about 5 to about 90. In a preferred embodiment, the alumina precursor is present in a wt % in the range of from about 20 to about 80. In a more preferred embodiment, the alumina precursor is present in a wt % in the range of from about 25 to about 75.

In the preparation of boehmite based sal gel corundums, the present inventive porous support method is easily able to accommodate suspended co-components such as alpha alumina seeds, synergists such as Y₂O₃, or lanthanides, growth inhibitors, such as for example, MgO, SiO₂, Cr₂O₃, ZrO₂, and other components as known as state of the art.

The term “component” is used for compounds which are present in the slurry. Such compounds might not necessarily appear in the final product due to their volatility and limited chemical inactivity. A component might function as a raw material (feedstock) or a dispersing additive, texture forming additive, mineralizer/annealing-calcination additive, and binder as well. A simple system might consist of 72% of super fine aluminum trihydroxide, of 28% of water, and of traces of a dispersing agent such as polyacrylate. This formulation, when applied to a support and subjected to a temperature of 1150° C. for about 30 min and even longer, becomes a novel polishing alpha alumina having a negligible incidence or even complete absence of large “outlier” particles. The additional use of a fluoride containing additive such as sodium fluoroborate (NaBF₄) promotes the formation of a relatively large platy-like primary crystal [0011] which is useful for filler applications (resin, rubber, plastic) in improving the mechanical strength and the thermal conductivity in these systems. For lapping applications platy crystals enhance the removal/cut rate of material surfaces.

A system can also be defined as a more complex one consisting for example of the dispersing phase water (31.3 wt %), aluminum phosphate in the function as a binder (5 wt %), iron powder having a particle diameter of less than 63 μm (11.4 wt %), and an alumina feedstock of finely precipitated aluminum trihydroxide (52.3 wt %). A thermal treatment at 600° C. gives a granulate containing activated alumina, which could be deployed for the purification of arsenic contaminated ground water.

One can possibly consider a formulation without any aluminum-containing compound. At 1300° C. stoichiometric magnesiochromite can be synthesized by aqueously suspended ultra-fine MgCO₃ and chromium (III) oxide powders according to following rough formulation (66.8 wt % water, 11.8 wt % MgCO₃, 21.3 wt % Cr₂O₃). Aluminum fluoride has to be found effective as a mineralizing and surface-active agent at a concentration of 0.5 wt % of the alumina feedstock. In case of magnesium spinel a stoichiometric ratio of 1 mol of Mg(OH)₂ and 2 mol of Al(OH)₃ are appropriate.

In one embodiment, the slurry comprises in the range of from about 5 to about 90 wt % of the additive. In a preferred embodiment the slurry comprises in the range of from about 20 to about 80 wt % of the additive. In a more preferred embodiment the slurry comprises in the range of from about 25 to about 75 wt % of the additive.

The slurries of the present invention can be formed by combining the liquid phase, such as, for example, water, with the powdered, dispersed and/or dissolved precursor(s), and additives. Dispersing agents such as, for example, polyacrylates or polyglycols, and wetting agents/surfactants such as, for example, sulphonic acids or carboxylates can enable high solid contents of the feedstocks and can stabilize the slurry at low viscosity. The liquid phase—preferably water but also feasibly acids, alcohols or organic liquids—may be added to the bulk precursor, or alternatively, the precursor may be added in bulk or by degree to the aqueous phase. In some cases, steady mixing may be preferred or even required. Mixing, dispersing, and homogenization can be conducted with a homogenizer, such as, for example, an Ultra Turrax.

Powdered components can be conveniently added as ultra-fine powders in the range of 1 to 2 μm. Co-grinding of oxide components might promote the thermal reactivity by mechanical activation prior to heat treatment (annealing). Alternatively, feedstocks, such as for example, pseudo boehmites can be added in a more dispersed form, such as dispersed as sol. Metallic salts can usually be conveniently added as aqueous solutions. For instance, copper sulfate heptahydrate can be dissolved in hot water (80° C.), and then used as a component of the slurry. Mineralizers can be used as finely ground powders. Some mineralizing agents, such as NaBF₄ easily dissolve when in contact with water.

The slurry is contacted with or otherwise applied to a porous, preferably polymeric support. The support preferably acts as an adsorber for the slurry, which preferably penetrates the pores of the support. The support may be situated within a saggar, or other removable or enclosing framework or carrier, if necessary, which restrains the flow or other motion of the applied slurry such that it remains in contact with the support prior to and during the next step, which includes heating.

The porous support is preferably a polymer foam or other porous support onto which the slurry can be adsorbed. Preferred polymer foams or other porous polymer supports which can used in the process of the present invention include polyether, polyurethane, polyesters, polyamides, polystyrene, cellulose, starch, polysaccharide or other structural materials.

The support is preferably lost to combustion and/or pyrolysis prior to the phase change reaction. However, included within the ambit of the present invention are embodiments in which the porous support does not burn or pyrolyze cleanly away even to an extent that it requires separation from the final product, after agglomeration, if applicable. In other embodiments, the particulate remains in the support after heat treatment and is separated from the porous support, such as with ultrasonic methods, or by washing/leaching out with water. In yet a further embodiment, the porous support is formed in situ. An example of such is the addition of reactive support-forming components to the aqueous slurry such as the addition of isocyanates, which react with water to form a polyurea and subsequently to biurete framework, or by adding polyole compounds to give polyurethane formation. Shaping of the substrate-charged foam could be performed by extrusion.

The porous substrate used is preferably one, which can be separated from the slurry once the product formation reaction has occurred. In other embodiments, the separation occurs prior to the particulation of the alpha alumina product or to solid state reactions, such as, for example, by complete combustion. In an aforementioned embodiment, the separation occurs due to thermal decomposition or combustion of the support, such as, for example, due to the elevated temperatures attained in order to cause the formation of alpha alumina or the desired mineral compound. In other embodiments the separation occurs after or upon particulation of the alpha alumina product or the resulting mineralogical product. For example, the support may be reduced to particulate along with the mineral product.

The support is preferably of an “open-cell” structure. By “open-celled,” it is meant that at least some superficial pores in the support are spatially contiguous with cells within the body of the support, and at least some of such cells are spatially contiguous with each other. In general, such a structure is commonly seen in polymeric foams or sponges and other materials which have cavities as a result of bubbles of retained gas. Other types of porous supports, which are formed by mechanisms other than retained gas bubbles can be used. For example, in some embodiments, cellulose-containing supports, such as those fabricated from wood, wood pulp, particulate cellulose, and the like can be used.

In an embodiment, the support is lost to combustion during the heating, such as, for example, the temperature increase which gives rise to the alpha transition or to the dedicated mineral phase. In such embodiments, the support can be cleanly combustible, such that residues are minimized. In other embodiments, the combustion of the support can leave residues, which can be removed, if desired by processes including washing or chemical processes. In other embodiments, the support is particulated along with the alpha alumina product, and subsequently separated out. Organic materials such as polymerized hydrocarbons or other materials, which are cleanly combustible, are preferred. It should be noted that in the case of product used for polishing applications, the presence of ash often presents no problem.

In some embodiments the treatment temperature of the alumina feedstock is below the alpha transition temperature. In one embodiment dedicated to flame retardation applications, the alumina precursor is heated to a temperature of at least 80° C. In another embodiment dedicated to the use as an activated alumina for use as adsorbents and catalysts, the temperatures are preferably in the range of from about 300° C. to about 1000° C. The alumina precursor is heated to one or more temperatures for a time such that some or all of the alumina precursor undergoes the alpha transition, and crystal growth is controlled or promoted. In an embodiment to the deployment as an alpha alumina for polishing, filler, or ceramic applications, the thermal treatment is in the continual range of alpha transformation from about 800° C. and to about 1400° C. In additional embodiments, the alumina precursor is heated to one or more temperature cycles above the alpha transition temperature for a time of at least 10 minutes at appropriate temperature in order to achieve the transition and the related crystal growth of the primary particles.

The aqueous slurry can be applied to the support in a variety of modes, depending upon the thickness/viscosity and solid content of the slurried alumina. The soaking, impregnation, process of filling the support, be it a foam, a sponge or other slurry adsorbing material, can be facilitated by vacuum, pressure, ultra sonic, and/or a wetting agents. It is generally advantageous to maximize loading by measures such as those mentioned herein. Besides the improved economy of manufacturing agglomerates formed from highly concentrated slurries, the resulting product is denser in bulk, and such material can be easier to handle in subsequent processing steps. Low viscosity slurries and conditions which give low interfacial tension tend to favor more complete saturation. In one embodiment, the slurried alumina is applied to the support such that it is drawn into the support.

Prior deformation of the support by pressing can increase the amount of slurry drawn into the support. In another embodiment, the slurry is applied to the support such that it is pressed into external support pores. Generally, the charging of the support occurs prior to thermal treatment, and can often be accomplished in times significantly less than one minute, with larger pore sizes generally giving easier and faster charging. In a continuously loaded and driven furnace, such as a tunnel kiln or a roller kiln, the charged support, either by itself or in a separate box or enclosure, can be appropriately handled. In an embodiment, which is particularly effective, especially for slurries which are optimized to be thin/low viscose, or which do not adhere readily to the support, the support is placed in or enclosed within an “open top” saggar. The slurry is loaded into the saggar on top of and, preferably onto the sides of, and optionally, sideward of the inserted support. In one embodiment, the support is placed within the saggar after the saggar has been filled with the slurry. In a preferred embodiment, the support is placed in the saggar, and is subsequently entirely buried by the slurry. In order to optimize use of the available capacity of the furnace, it can be of advantage to stack the filled saggars. In some embodiments, surface-active substances, dispersing agents, wetting agents, interfacial tension reducing additives, binders, mineralizers—the latter used as crystal shape and crystal size controlling additives—are primary ingredients of the slurry. Wetting the support with a liquid and the use of wetting agents with subsequent wringing out of the liquid content can occur prior to soaking with the slurry. Adequately but not necessarily, the slurry might be pre-heated close to the boiling point of the liquid or close to the volatilization of any of the additives. The saggar enclosed support is then subjected to the heating step.

For products, which do not undergo a particulation process such as desagglomeration, the diameter of the pores/cavities of the support have a determining impact on the final product. The selection of the pore diameter of the support should generally be in accordance with the agglomerate size required by the application. The resulting agglomerates roughly reproduce the pore size distribution of the support. On the contrary, if the final product is to be a particulate, desagglomeration will likely be required. Such final products can generally be manufactured by supports of a wide range of pore diameter characteristics. Subsequent desagglomeration by milling to the state of aggregate size or even to primary particle size can be conducted, with the resulting particulate size independent of the pore size of the support and agglomerate size of the thermally treated intermediate product. However, if an agglomerated product is to undergo a comminution process, a finely sized pore size of the support and a loosely packed highly porous granulate can be helpful to reduce the expenditure for milling. Note that for storage, it is preferred, but not essential, that the slurry have the ability to store without sedimentation for at least the storage time under the storage conditions.

Fine pore size diameters can be chosen for applications, which involve further milling, which can be done by means of ultrasonic, comminution in an impact mill, pin mill, jet mill, ball mill, attrition mill, and even simply in the meaning of grinding/friction with a mortar and pestle, etc. Coarse diameters are appropriate for adsorptive use, such as, for instance, the purification of contaminated liquids or other applications which require little or no comminution.

In order to accelerate the filling process of the support, a wider pore size is generally preferred. Generally, as a very rough, but not exclusive guide, a pore diameter of at least two times of the slurry's coarsest grain fraction is recommended. Coarse grains in the feedstock at size of the smallest pore diameter can impair saturation by reducing the connectivity of the cavities and thus the affinity of the support for the slurry.

As indicated herein, it is generally more economical to use a slurry having a high solid load and a support having a high degree of filling or saturation. The particle packing of a powder which is present in a high solid slurry is often denser compared to that of the same powder mechanically dry-pressed at high pressure. Such a result is explained by the more ideal spatial distribution of the particles in a slurry which promotes a closer package of the particles, and consequentially less porosity. Textural effects in the resulting product of characteristics such as porosity of the agglomerate and its size are in relation to the pore diameter of the support and the solid content of the slurry. Lower solid load generally results in a higher porosity and a detectable but less decisive fineness of the granulate. A priori, the particle size of the feedstock has a determining effect on the final product and its porosity. However, the greatest impact on micro porosity of the resulting product is forwarded/triggered by the effective temperature and its profile. For instance, temperature can have a high impact on the specific surface area/micro porosity, if the final alumina product is manufactured in the transition range from aluminum hydroxide to boehmite or subsequently to transition aluminas. At higher transition temperatures to alpha alumina, the specific surface area drops significantly due to accretive crystallization and crystal growth in tending to zero at high temperatures >>1500° C. Mineralizers, for instance fluoride containing annealing additives, deployed at the alpha transition zone, generally reduce the porosity by promoting crystal growth, resulting in a low specific surface area.

As an illustration of the effect of temperature, FIG. 10 corresponds to a product alpha alumina having a particle size distribution of 100%<6 μm, which fairly closely corresponds to the initial grain size distribution of the feedstock aluminum hydroxide Martinal™ OL-107 LEO. The pre-des agglomeration product (thermally treated at 1200° C.) has been simply and easily desagglomerated by means of a pin mill to the aggregate size, which is in line with the original grain size of the feedstock. This desagglomerated alpha alumina powder is dedicated to polishing applications. As shown by scanning microscope picture, due to transition to alpha alumina, the average primary particle size is around 250 nm, significant smaller than the distinct aggregates at around 1.7 μm. For some highly sophisticated ceramic applications, nano-ground powder at a d₅₀ of <0.4 μm is required, which needs additional intense milling to break the aggregates into the primary crystals. Downsizing to the primary crystal requires a great amount of milling, mostly achieved by a nano mill, a type of a specially equipped attrition mill. Such a powder could function as a ceramic feedstock for mechanically strengthened ceramics or as a seed in sol gel production. In contrast to [0012, FIG. 11], Martinal™ OL-107 LEO has been treated at 1200° C. in presence of the mineralizing agent AlF₃ (growth promoter). As demonstrated by the scanning microscope picture, the initial grain size of the feedstock and the influence by the annealing additive have been the determining factors besides temperature. The primary crystal has accomplished at least the size of the aggregates and partially exceeded the aggregate size due to accretive crystallization shown in [0009, FIG. 10]. The comminution into the primary crystals requires relatively little milling energy. Such a product preferably serves as a filler additive.

### EXAMPLES

The Examples correspond to embodiments as follows:

### Polish/Abrasive

Example 1
Example 2 (surface modified with acetic acid)
Example 3 (dispersant)
Example 4, 5, 6 (PEG, friability)
Example 9, 10 (seeding)
Example 11: (change in polymeric support)
Example 13: pseudo boehmite (binder) only, sal gel
Example 15: pseudo boehmite (binder), seeds, sol gel
Example 17: aluminium trihydroxide (ATH), pseudo boehmite (binder), seeds, sol gel
Example 19: ATH, pseudo boehmite (binder), seeds, sol gel, friability
Example 20 and 21: seeds
Example 22 and 23: ATH, pseudo boehmite (binder), seeds, sol gel
Example 24 and 25: ATH, pseudo boehmite (binder), seeds, sol gel, friability
Example 27 and 28: thickening of slurry, cerium acetate
Example: 29: Ti-doped alumina
Example: 30: Mn-doped alumina
Example 34: from aluminium salt
Example 43: ATH, pseudo boehmite (binder)
Example 46: undispersed with dispersed pseudo boehmite
Example 47: pseudo boehmite, magnesium chloride (granule strength, slurry viscosity)
Example 51: pseudo boehmite, ATH, magnesium chloride (granule strength, slurry viscosity)
Example 52: sol gel (granule strength)
Example 53: sol gel (granule strength, ceramic microstructure)

Lapping/Filler
Example 7 (fluoridization/NaBF₄) phase transition, grain growth, particle shape)
Example 8 (fluoridiz./NaBF₄, cerium acetate) phase transition, grain growth, particle shape)
Example 31: AlF₃
Example 32: AlF₃, adulterant of alpha alumina
Example 33: NaBF₄, adulterant of alpha alumina

Non-Particulate Applications
Example 12: pseudo boehmite (binder) only, sol gel
Example 14: pseudo boehmite (binder), seeds, sol gel
Example 16: ATH, pseudo boehmite (binder), seeds, sol gel
Example 18: ATH, pseudo boehmite (binder), seeds, sol gel, friability
Example 41: aluminium phosphate binder
Example 42: ATH, pseudo boehmite (binder)
Example 44: assemblage iron oxide (from salt)and alumina
Example 45: assemblage iron oxide (from iron powder)and alumina
Example 46: undispersed with dispersed pseudo boehmite
Example 48: pseudo boehmite, magnesium chloride (granule strength, slurryviscosity)
   Example 50: pseudo boehmite, ATH, magnesium chloride (granule strength, slurry viscosity)

Multinary Mineral
Example 26: magnesium aluminate with magnesium chloride
Example 35: pigment cobalt blue
Example 36 and 37: magnesium spine
Example 38: magnesiochromite
Example 39: magnesium aluminate
Example 40: Si-doped aluminum titanate
Table 2 gives further details of each Example.

TABLE 2

| | | Type of | Av. Pore Size | | |
|---|---|---|---|---|---|
| EX. | Application | Support | [mm] | Type of Kiln | Heating Ramp |
| 1 | high gloss polishing | polyether | 2.5 | industrial gas-fired box | 100° K/h to 1150° C. |
| 2 | high gloss polishing | polyether | 2.5 | industrial gas-fired box | 100° K/h to 1200° C. |
| 3 | high gloss polishing | polyether | 2.5 | industrial gas-fired box | 100° K/h to 1150° C. |
| 4 | high gloss polishing | polyurethane | 0.6 | stat. elec. lab. furnace | 1 h to 1200° C. |
| 5 | high gloss polishing | polyurethane | 0.6 | stat. elec. lab. furnace | 3 stages to 1200 C. |
| 6 | high gloss polishing | polyether | 2.5 | stat. elec. lab. furnace | 3 stages to 1200 C. |
| 7 | lapping/filler | polyether | 2.5 | stat. elec. lab. furnace | directly at 1200° C. |
| 8 | lapping/filler | polyether | 2.5 | stat. elec. lab. furnace | directly at 1200° C. |
| 9 | high gloss polishing/abrasive | polyether | 0.4 | stat. elec. lab. furnace | 1 h to 1000° C. |
| 10 | high gloss polishing/abrasive | polyether | 0.4 | stat. elec. lab. furnace | 1 h to 1200° C. |
| 11 | high gloss polishing applications | polyurethane | 0.4 | stat. elec. lab. furnace | 1 h to 1200° C. |
| 12 | adsorption | polyurethane | 0.15 | stat. elec. lab. furnace | 1 h to 600° C. |
| 13 | high gloss polishing/abrasive | polyurethane | 0.15 | stat. elec. lab. furnace | 1 h to 1200° C. |
| 14 | high gloss polishing/abrasive | polyurethane | 0.4 | stat. elec. lab. furnace | 1 h to 1000° C. |
| 15 | high gloss polishing/abrasive | polyurethane | 0.4 | stat. elec. lab. furnace | 1 h to 1200° C. |
| 16 | gloss polishing/abrasive/ceramics | polyurethane | 0.4 | stat. elec. lab. furnace | 1 h to 1000° C. |
| 17 | gloss polishing/abrasive/ceramics | polyurethane | 0.4 | stat. elec. lab. furnace | 1 h to 1200° C. |
| 18 | gloss polishing/abrasive/ceramics | polyurethane | 0.6 | stat. elec. lab. furnace | 1 h to 1000° C. |
| 19 | gloss polishing/abrasive/ceramics | polyurethane | 0.6 | stat. elec. lab. furnace | 1 h to 1200° C. |
| 20 | gloss polishing/abrasive/ceramics | polyether | 0.3 | stat. elec. lab. furnace | 1 h to 1200° C. |
| 21 | gloss polishing/abrasive/ceramics | polyether | 0.3 | stat. elec. lab. furnace | 1 h to 1400° C. |
| 22 | gloss polishing/abrasive/ceramics | polyurethane | 0.6 | stat. elec. lab. furnace | 1 h to 1000° C. |
| 23 | gloss polishing/abrasive/ceramics | polyurethane | 0.6 | stat. elec. lab. furnace | 1 h to 1200° C. |
| 24 | gloss polishing/abrasive/ceramics | polyurethane | 0.6 | stat. elec. lab. furnace | 1 h to 1000° C. |
| 25 | gloss polishing/abrasive/ceramics | polyurethane | 0.6 | stat. elec. lab. furnace | 1 h to 1200° C. |
| 26 | gloss polishing/abrasive/ceramics | polyether | 2.5 | stat. elec. lab. furnace | 1 h to 1000° C. |
| 27 | gloss polishing/abrasive/ceramics | polyether | 2.5 | stat. elec. lab. furnace | 1 h to 1000° C. |
| 28 | gloss polishing/abrasive/ceramics | polyether | 2.5 | stat. elec. lab. furnace | 1 h to 1200° C. |
| 29 | gloss polishing/abrasive/ceramics | polyether | 2.5 | stat. elec. lab. furnace | 3 stages to 1200 C. |
| 30 | gloss polishing/abrasive/ceramics | polyurethane | 0.6 | stat. elec. lab. furnace | 3 stages to 1200 C. |
| 31 | lapping/filler | polyether | 0.3 | stat. elec. lab. furnace | 1 h to 1200° C. |
| 32 | lapping/filler | polyurethane | 0.6 | stat. elec. lab. furnace | directly at 1200° C. |
| 33 | lapping/filler | polyurethane | 0.6 | stat. elec. lab. furnace | directly at 1200° C. |
| 34 | high gloss polishing | polyether | 2.5 | stat. elec. lab. furnace | 3 stages to 1150 C. |
| 35 | spinel, spinel-based pigments | polyether | 0.4 | stat. elec. lab. furnace | 330° K/h to 1200° C. |
| 36 | spinel, spinel-based pigments | polyether | 0.4 | stat. elec. lab. furnace | 330° K/h to 1200° C. |
| 37 | spinel, spinel-based pigments | polyether | 0.4 | stat. elec. lab. furnace | 330° K/h to 1400° C. |
| 38 | spinel, spinel-based pigments | polyether | 0.4 | stat. elec. lab. furnace | 330° K/h to 1400° C. |
| 39 | spinel, spinel-based pigments | polyether | 0.4 | stat. elec. lab. furnace | 330° K/h to 1400° C. |
| 40 | aluminum titanate, engin. ceramics | polyether | 0.4 | stat. elec. lab. furnace | 1 h to 1400° C. |
| 41 | granulation: adsorption, catalysis | polyether | 0.4 | stat. elec. lab. furnace | 1 h to 600° C. |
| 42 | granulation: adsorption, catalysis | polyurethane | 0.6 | stat. elec. lab. furnace | 1 h to 600° C. |
| 43 | gloss polishing/abrasive/ceramics | polyurethane | 0.6 | stat. elec. lab. furnace | 1 h to 1200° C. |
| 44 | granulation: adsorption | polyurethane | 0.4 | stat. elec. lab. furnace | 1 h to 600° C. |
| 45 | granulation: adsorption | polyurethane | 0.4 | stat. elec. lab. furnace | 1 h to 600° C. |
| 46 | granulation: adsorption, catalysis | polyether | 2.5 | stat. elec. lab. furnace | 1 h to 560° C. |
| 47 | gloss polishing/abrasive/ceramics | polyether | 2.5 | stat. elec. lab. furnace | 1 h to 1200° C. |
| 48 | adsorption | polyether | 2.5 | stat. elec. lab. furnace | 1 h to 600° C. |
| 49 | gloss polishing/abrasive/ceramics | polyether | 2.5 | stat. elec. lab. furnace | 1 h to 1400° C. |
| 50 | adsorption | polyether | 2.5 | stat. elec. lab. furnace | 1 h to 600° C. |
| 51 | gloss polishing/abrasive/ceramics | polyether | 2.5 | stat. elec. lab. furnace | 1 h to 1400° C. |
| 52 | gloss polishing/abrasive/ceramics | polyether | 2.5 | stat. elec. lab. furnace | 1 h to 1400° C. |
| 53 | gloss polishing/abrasive/ceramics | polyether | 2.5 | stat. elec. lab. furnace | 3 h to 1600° C. |

| | retention | | | | | | Additive1 |
|---|---|---|---|---|---|---|---|
| EX. | time | de-min. H₂O | Feed1 | Al(OH)₃ | Feed2 | Feed3 | Wt % |
| 1 | 5 | balance | Martigloss ™ | 68 Al(OH)₃ | | | |
| 2 | 5 | balance | Martinal ™ OL-107 LEO | 71.9 Al(OH)3 | | | 3.5 acetic acid |
| 3 | 5 | balance | Martinal ™ OL-107 LEO | 71.7 Al(OH)₃ | | | 0.3 Dolapix ™ PC 21 |
| 4 | 1 | balance | Martifin ™ OL-005 | 69 Al(OH)3 | | | 1.4 PG 20000 |
| 5 | 2 | balance | Martinal ™ OL-111 LE | 52.7 Al(OH)3 | | | 2.1 PG 20000 |
| 6 | 2 | balance | Martinal ™ OL-111 LE | 52.7 Al(OH)3 | | | 2.1 PG 20000 |
| 7 | 1 | balance | Martinal ™ OL-107 LEO | 71.2 Al(OH)₃ | | | 0.3 Dolapix ™ PC 21 |
| 8 | 1 | balance | Martinal ™ OL-107 LEO | 55 Al(OH)3 | | | 0.7 CeAc |
| 9 | 1 | balance | Martinal ™ OL-107 LEO | 39 Al(OH)₃ | 6.6 Disperal ™ P3 | 4 alpha seeds | |
| 10 | 1 | balance | Martinal ™ OL-107 LEO | 39 Al(OH)₃ | 6.6 Disperal ™ P3 | 4 alpha seeds | |
| 11 | 1 | balance | Martinal ™ OS | 66 Al(OH)₃ | | | |
| 12 | 1 | balance | | | 15 Disperal P3 | | |
| 13 | 1 | balance | | | 15 Disperal P3 | | |
| 14 | 1 | balance | | | 11.5 Disperal P3 | 5.8 alpha seeds | |
| 15 | 1 | balance | | | 11.5 Disperal P3 | 5.8 alpha seeds | |
| 16 | 1 | balance | Martinal ™ OL-111 LE | 40.5 Al(OH)₃ | 6.6 Disperal ™ P3 | 3.9 alpha seeds | |
| 17 | 1 | balance | Martinal ™ OL-111 LE | 40.5 Al(OH)₃ | 6.6 Disperal ™ P3 | 3.9 alpha seeds | |
| 18 | 1 | balance | Martinal ™ OL-111 LE | 42.3 Al(OH)₃ | 6.5 Disperal ™ P3 | 2.9 alpha seeds | 1.3 oleic acid |
| 19 | 1 | balance | Martinal ™ OL-111 LE | 42.3 Al(OH)₃ | 6.5 Disperal ™ P3 | 2.9 alpha seeds | 1.3 oleic acid |
| 20 | 1 | balance | | | | 22 alpha seeds | |
| 21 | 1 | balance | | | | 22 alpha seeds | |
| 22 | 1 | balance | Martinal ™ OL-111 LE | 58 Al(OH)₃ | 4.7 Disperal ™ P3 | 2.2 alpha seeds | |
| 23 | 1 | balance | Martinal ™ OL-111 LE | 58 Al(OH)₃ | 4.7 Disperal ™ P3 | 2.2 alpha seeds | |
| 24 | 1 | balance | Martinal ™ OL-111 LE | 53.3 Al(OH)₃ | 4.4 Disperal ™ P3 | 2 alpha seeds | 0.9 oleic acid |
| 25 | 1 | balance | Martinal ™ OL-111 LE | 53.3 Al(OH)₃ | 4.4 Disperal ™ P3 | 2 alpha seeds | 0.9 oleic acid |
| 26 | 1 | balance | | | 10.4 Disperal ™ P3 | 0.35 alpha seeds | 7.1 MgCl2•6H2O |
| 27 | 1 | balance | — | — | 9.6 Disperal ™ P3 | 0.3 alpha seeds | 0.4 acetic acid |
| 28 | 1 | balance | — | — | 9.6 Disperal ™ P3 | 0.3 alpha seeds | 0.4 acetic acid |
| 29 | 2 | balance | Martinal ™ OL-111 LE | 44.6 Al(OH)₃ | | 0.26 TiO₂ | |
| 30 | 2 | balance | Martinal ™ OL-111 LE | 41.4 Al(OH)3 | | 0.75 | |
| | | | | | | Mn(II)Cl₂•4H₂O | |
| 30 | 2 | balance | Martinal ™ OL-107 LEO | 71.2 Al(OH)₃ | | | 0.3 Dolapix ™ PC 21 |
| 32 | 1 | balance | 59.5 Martoxid ™ PN-202 | | | | |
| 33 | 1 | balance | 69.5 Martoxid ™ MRS-1 | | | | |
| 34 | 2 | balance | Martinal ™ OL-107 LEO | 40 Al(OH)₃ | 0.6 × 0.4 Al-formate | | |
| 35 | 2 | balance | Martinal ™ OL-111 LE | 21.8 Al(OH)₃ | | 39.2 Co(II)SO₄•7H₂O | |
| 36 | 1 | balance | Martinal ™ OL-104 LE | 36.4 Al(OH)₃ | 13.6 H10, | | |
| | | | | | Mg(OH)₂ | | |
| 37 | 1 | balance | Martinal ™ OL-104 LE | 36.4 Al(OH)₃ | 13.6 H10, | | |
| | | | | | Mg(OH)₂ | | |
| 38 | 1 | balance | | | 11.8 MgCO₃ | 21.3 Cr₂O₃ | 0.03 Antiprex 6340 |
| 39 | 1 | balance | 25.5 Martoxid ™ MRS-1 | | 14.6 H10, | | |
| | | | | | Mg(OH)₂ | | |
| 40 | 1 | balance | Martinal ™ OL-111 LE | 35.8 Al(OH)₃ | 18.3 TiO₂ | 0.1 SiO₂ | |
| 41 | 1 | balance | Martinal ™ OL-104 LE | 56.7 Al(OH)₃ | 5.5 Al-phosphate | | |
| 42 | 1 | balance | Martinal ™ OL-104 LE | 45.3 Al(OH)₃ | 8.2 Disperal ™ P3 | | |
| 43 | 1 | balance | Martinal ™ OL-104 LE | 45.3 Al(OH)₃ | 8.2 Disperal ™ P3 | | |
| 44 | 1 | balance | Martinal ™ OL-111 LE | 20.6 Al(OH)₃ | 3.7 Disperal ™ P3 | 15.1 FeCl₂•4H₂O | |
| 45 | 1 | balance | Martinal ™ OL-111 LE | 52.3 Al(OH)₃ | 5 Al-phosphate | 11.4 Fe | |
| 46 | 1 | balance | | | 60 Disperal ™ P3 | | |
| 47 | 1 | balance | | | 60 Disperal ™ P3 | | |
| 48 | 1 | balance | | | 18.6 Disperal ™ P3 | 0.2 Hac | 0.2 AlCl3 |
| 49 | 2 | balance | | | 18.6 Disperal ™ P3 | 0.2 Hac | 0.2 AlCl3 |
| 50 | 1 | balance | Martinal ™ OL-111 LE | 16.7 Al(OH)3 | 15.4 Disperal ™ P3 | 0.1 Hac | |
| 51 | 2 | balance | Martinal ™ OL-111 LE | 16.7 Al(OH)3 | 15.4 Disperal ™ P3 | 0.1 Hac | |
| 52 | 2 | balance | | | 9.7 Disperal ™ P3 | 14.9 alpha seeds | 0.1 Hac |
| 53 | 2 | balance | | | 9.7 Disperal ™ P3 | 14.9 alpha seeds | 0.1 Hac |

| | Additive2 | | BET | PSD [μm] | | | | |
|---|---|---|---|---|---|---|---|---|
| EX. | [w %] | desagglomeration | [m²/g] | d10 | d50 | d90 | d100 | SEM |
| 1 | | | ind. jet mill | 13.6 | 0.5 | 1.2 | 3.0 | 8 |
| 2 | 3.5 acetic acid | | Alpine AFG 200 | 7.3 | 0.7 | 1.6 | 3.0 | 6 |
| 3 | 0.3 Dolapix ™ PC 21 | | ind. jet mill | 10.3 | 0.75 | 1.6 | 3.0 | 6 |
| 4 | 1.4 PG 20000 | | | 14.6 | | 1-6 | | |
| 5 | 2.1 PG 20000 | | | | | | | |
| 6 | 2.1 PG 20000 | | | | | | | |
| 7 | 0.3 Dolapix ™ PC 21 | 0.4 NaBF₄ | mortar/pestle | 0.7 | | 5-15 | | |
| 8 | 0.7 CeAc | 0.4NaBF4 | mortar/pestle | 0.9 | | 5-15 | | |
| 9 | | | mortar/pestle | 30 | | | | |
| 10 | | | soft: mortar/pestle | 6 | | | | |
| 11 | | | soft: mortar/pestle | 8 | | | | |
| 12 | | | soft: mortar/pestle | 230 | | | | |
| 13 | | | soft: mortar/pestle | 9 | | | | |
| 14 | | | soft: mortar/pestle | 19 | | | | |
| 15 | | | soft: mortar/pestle | 8 | | | | |
| 16 | | | soft: mortar/pestle | 29.5 | | | | |
| 17 | | | soft: mortar/pestle | 5.5 | | | | |
| 18 | 1.3 oleic acid | | soft: mortar/pestle | 34 | | | | |
| 19 | 1.3 oleic acid | | soft: mortar/pestle | 6 | | | | |
| 20 | | | soft: mortar/pestle | 7 | | | | |
| 21 | | | soft: mortar/pestle | 2.5 | | | | |
| 22 | | | soft: mortar/pestle | 32 | | | | |
| 23 | | | soft: mortar/pestle | 6 | | | | |
| 24 | 0.9 oleic acid | | soft: mortar/pestle | 34 | | | | |
| 25 | 0.9 oleic acid | | soft: mortar/pestle | 6 | | | | |
| 26 | | soft: mortar/pestle | 36 | | | | | |
| 27 | 0.7 CeAc | soft: mortar/pestle | 53 | — | — | — | — | |
| 28 | 0.7 CeAc | soft: mortar/pestle | 8 | — | — | — | — | X |
| 29 | | unground | 9.9 | 0.7 | 2.5 | 14 | 32 | |
| 30 | | unground | 8.6 | | | | | X |
| 31 | 0.5 AlF₃ | soft: mortar/pestle | 0.7 | | 2-6 | | | X |
| 32 | 0.5 AlF₃ | soft: mortar/pestle | 0.6 | | | | | X |
| 33 | 0.5 NaBF₄ | soft: mortar/pestle | 1.0 | | | | | X |
| 34 | | disk vib. mMill 15 s | 12.7 | 0.75 | 1.7 | 3.3 | 6 | |
| 35 | | mortar grinder 2 min | 7.5 | 0.5 | 1.4 | 26 | 56 | |
| 36 | | mortar grinder 2 min | | | | | | |
| 37 | | mortar grinder 5 min | | 0.58 | 1.78 | 26.9 | 56 | |
| 38 | | mortar grinder 5 min | 1.9 | 0.89 | 5.3 | 12.8 | 24 | |
| 39 | | unground | 2.7 | | | | | X |
| 40 | | unground | 0.6 | | | | | |
| 41 | | ungrd. 72% >1.6 mm | 155 | | | | | |
| 42 | | av. granule 0.6 mm | 188 | | | | | |
| 43 | | av. granule 0.6 mm | 12 | | | | | |
| 44 | | ungrd. 65% >250 μm | 110 | | | | | |
| 45 | | ungrd. 71% >250 μm | 115 | | | | | |
| 46 | | ungrd., ca. 5 mm | 210 | | | | | |
| 47 | | ungrd., ca. 5 mm | 6 | | | | | |
| 48 | 0.2 MgCl₂ | unground | 220 | | | | | |
| 49 | 0.2 MgCl₂ | unground | 1.6 | | | | | |
| 50 | 0.15 MgCl₂ | unground | 200 | | | | | |
| 51 | 0.15 MgCl₂ | unground | 3.0 | | | | | |
| 52 | 0.1 MgCl₂ | unground | 1.0 | | | | | |
| 53 | 0.1 MgCl₂ | unground | 0.06 | | | | | X |

| | | granule strength [N] | |
|---|---|---|---|
| EX. | phase | [granule size 2 mm] | remarks |
| 1 | | | |
| 2 | | | |
| 3 | | | |
| 4 | | | good granule |
| | | | flowability |
| 5 | | | good granule |
| | | | flowability |
| 6 | | | good granule |
| | | | flowability |
| 7 | | | |
| 8 | | | Na2O 0.2% |
| 9 | transition | | |
| 10 | corundum | | |
| 11 | | | |
| 12 | | | |
| 13 | | | |
| 14 | corundum | | |
| 15 | corundum | | |
| 16 | transition | | |
| 17 | corundum | | |
| 18 | transition | | |
| 19 | corundum | | |
| 20 | | | |
| 21 | | | |
| 22 | | | |
| 23 | | | |
| 24 | | | |
| 25 | | | |
| 26 | corundum, Mg-spinel | | |
| 27 | corundum, delta, cerianite | | |
| 28 | corundum, cerianite | | |
| 29 | corundum, theta, kappa | | |
| 30 | corundum, theta, kappa | | prim. crystal 0.1- |
| | | | 0.2 μm |
| 31 | | | |
| 32 | | | |
| 33 | | | |
| 34 | corundum, kappa | | |
| 35 | Co-aluminate, minor alpha | | |
| 36 | Mg-spinel, trace periclase | | |
| 37 | Mg-spinel | | |
| 38 | Mg-chromite, trace Cr₂O₃ | | |
| 39 | Mg-spinel | | |
| 40 | Al-titanate | | |
| 41 | | | |
| 42 | | | |
| 43 | | | |
| 44 | | | |
| 45 | | | |
| 46 | | | |
| 47 | | | |
| 48 | | ca. 20 | |
| 49 | | ca. 30 | |
| 50 | | ca. 30 | |
| 51 | | ca. 35 | |
| 52 | | >40 | |

| | |
|---|---|
| 53 | >150; out of detect. limit |

### Example 1

The particles prepared by the method of this example are particularly appropriate for high gloss polishing applications. A slurry was formed from Martigloss™ containing 68 wt % Al(OH)₃ and 32 wt % de-mineralized water. The compounds were homogeneously mixed and poured on a saggar, which contained a porous polyether sponge support with an average pore size of 2.5 mm. The inlet-saggar support system was heated in an industrial gas-fired box kiln at a rate of 100° K/h from room temperature to 1150°. The holding time at maximum temperature was 5 hours. After desagglomeration in an air-jet-mill without classifier installation, a grain size distribution having a d₅₀ of 1.2 μm and a d₉₀ of 3 μm was measured with the laser granulometer Cilas™ 1064. The BET has been determined at 14 m²/g (Gemini VI).

### Example 2

The particles prepared by the method of this example are particularly appropriate for high gloss polishing applications. A slurry was formed from 71.9 wt % Al(OH)₃, Martinal™ OL-107 LEO containing 24.6 wt % de-mineralized water. 3.5 wt % acetic acid, functioning as a surface modifier and dispersant, has been added to the de-mineralized water before addition of the powder.

After homogeneously mixing the slurry, the slurry is applied to the same type of saggar-enclosed sponge and in the same manner as Example 1. The sample is subjected to a heating ramp at 100° K/h and a retention time for 5 hours at a maximum temperature of 1200° C. After desagglomeration in an air-jet mill, a grain size distribution having a d₅₀ of 1.6 μm and a d₉₀ of 3 μm was measured with a laser granulometer Cilas™ 1064. The BET surface was determined to be 7 m²/g (Gemini VI).

Milling was conducted in an air-jet mill (Alpine AFG 200). The processing conditions were
Milling parameters of mill:
Nozzle diameter, 4 mm

Pressure, 8 bar

Filling degree, 16 kg

Throughput rate, 70 -100 kg/h
Parameters of air classifier:
Rotation, 3000 -3200 rpm

Current uptake, 2.8 3.0Λ

The desagglomeration settings were chosen such that the agglomerates, which were separated into their component particles, were essentially separated, but the component particles were essentially not reduced further in size.

### Example 3

The particles prepared by the method of this example are particularly appropriate for high gloss polishing applications.

A slurry was formed from 71.7 wt % Al(OH)₃, Martinal™ OL-107 LEO, 0.3 wt % Dolapix™ PC 21 (a dispersant, deflocculating agent), and 28 wt % de-mineralized water. The compounds were homogeneously mixed and poured on a saggar-inserted porous polyether sponge support with an average pore size of 2.5 mm The sponge inlet-saggar system was heated at a rate of 100° K/h from room temperature to 1150° C. in an industrial gas-fired box kiln. Holding time at maximum temperature was 5 hours. The sponge and the preparation of the sample were as in Example 1.

After desagglomeration in a jet-mill a grain size distribution of a d₅₀ of 1.6 μm and d₉₀ of 3 μm was measured with a laser granulometer Cilas™ 1064. The BET was determined at 10 m²/g (Gemini™ VI).

### Example 4

The particles prepared by the method of this example are particularly appropriate for polishing and preparation of ceramics. Martifin OL-005, an aqueous aluminum trihydroxide slurry with a solid content of 70 wt %, was homogeneously mixed with PEG 20000 (1.4 wt % on solid content) until the PEG was dissolved. Subsequently the slurry was poured on a saggar-inserted polyurethane sponge with a pore diameter average of 0.6 mm. The saggar/support/slurry combination was placed in a stationary electric furnace and heated from room temperature to 1200° C. over 1 hour's time. The retention time at 1200° C. was an additional hour.

The granules are of the diameter of the pore size with easy handling by slightly increased strength. The granules are completely desagglomerated in a counter rotating pin mill. The resulting aggregate to which the agglomerate is reduced essentially reflects the initial aggregate size.

According to SEM photographs most particles are in the range of 1 to 6 μm. The primary crystal are ranging from 100 to 300 nm. The granule size diameter of the calcined granulate is at 40 wt % <250 μm.

### Example 5

The particles prepared by the method of this example are particularly appropriate for polishing and preparation of ceramics. A slurry was formed from 52.7 wt % Al(OH)₃, Martinal™ OL-111 LE, 2.1 wt % PEG 20000, and 45.2 wt % de-mineralized water. The PEG 20000 was stirred in water with an Ultra Turrax, until the PEG was dissolved. In the following step the aluminum trihydroxide was added and the suspension was homogeneously mixed. Subsequently the slurry was poured on a saggar-inserted polyether sponge with a pore diameter average of 0.6 mm. The saggar/support/slurry combination was placed in a stationary electric furnace. An up-heating was implemented in 3 stages:
From room temperature to 400° C. within 40 min and retention period per 1 hour.
From 400° C. to 800° C. within 40 min and retention period per 1 hour.
From 800° C. to 1200° C. within 40 min and retention period per 2 hours.
Thermal treatment was conducted for 2 hours at the maximal temperature of 1200° C.
   The post-calcination diameter of the granules was measured at 35 wt % <0.25 mm.

### Example 6

The trial of the Example 5 was repeated with a porous polyether sponge support having an average pore size of 2.5 mm. The post-calcination diameter of the granules was measured at 53 wt % <1.25 mm.

### Example 7

The particles prepared by the method of this example are particularly appropriate for applications such as lapping of silicon wafers. The component amounts are as follows:
71.2 wt % Al(OH)3, Martinal™ OL-107 LEO
0.4 wt % NaBF4
0.3 wt % Dolapix™ PC 21
28 wt % de-mineralized water
   All components were homogeneously mixed and the slurry was poured onto a polyether porous support (average pore size of 2.5 mm) inserted in a saggar. The saggar-inserted support system was directly placed in a stationary electric furnace at 1200° C. The holding time at this temperature was 2 hours. The resulting powder was desagglomerated via mortar and pestle. The NaBF₄ promoted primary crystals exhibited growth relative to the feedstock size and compared to a promoter-free alpha transition. The resultant primary crystal was 5 to 15 μm (as indicated by SEM). The BET surface area of the crystals was determined to be 0.7 m²/g.

### Example 8

In analogy to Example 7 aluminum trihydroxide was thermally treated in the presence of the mineralizer-combination NaBF₄ and cerium acetate. The particles prepared by the method of this example are particularly appropriate for applications such as lapping of silicon wafers. The component amounts are as follows:
55.0 wt % Al(OH)₃, Martinal™ OL-107 LEO
0.3 wt % NaBF₄
0.7 wt % cerium (II) acetate hydrate
44 wt % de-mineralized water
   All components were homogeneously mixed and poured onto a polyether porous support (average pore size of 2.5 min) inserted in a saggar. The saggar/support/slurry combination was directly placed in a stationary electric furnace at 1200° C. The holding time at this temperature was 2 hours. The resulting powder was desagglomerated via mortar and pestle. The NaBF₄ /cerium acetate promoted crystals exhibited growth relative to the feedstock size and compared to a promoter-free alpha transition. The resultant primary crystal was 5 to 15 μm (as indicated by SEM). The BET surface area of the crystals was determined to be 0.9 m²/g. The use of this specific mineralizer combination led to the formation of sharp-edged, platy shaped primary crystals.

### Examples 9 and 10

The particles prepared by the method of this example are particularly appropriate for applications such as polishing and abrasives. The component amounts were as follows:
39 wt % Al(OH)₃, Martinal™ OL-107 LEO
4 wt % alpha alumina seeds
6.6 wt % Disperal™ P3
50.4 wt % de-mineralized water

Disperal P3 (pseudo boehmite sol) was dispersed in de-mineralized water. Afterwards, the Martinal™ OL-107 LEO and alpha alumina seeds were added, and all compounds were homogeneously mixed together. The aqueous shiny was poured on a porous polyether support having an average pore size of 0.4 mm. The saggar/support/slurry combination was placed in a stationary electric furnace and heated from room temperature to 1000° C. over 1 hour's time. The retention time at 1000° C. was 1 hour. The resulting particles, ground via mortular grinder for 15 min, had a BET of 30 m²/g and belong to the high thermal transition range, but below the alpha phase transition.

In comparison, the 2^{nd} treatment over a retention time of 1 hour at 1200° C. and with a preceding up-ramping from room temperature to 1200° C. even over 1 hour's time is clearly indicated as corundum phase showing a BET surface area of 6 m²/g. This more intense thermal treatment demonstrates phase transition to alpha and related crystal growth. Comparing the 1000° C.-treatments of Examples 9 to 10 and Examples 14 to 15, latter is only based upon pseudo boehmite and seeds, the reaction to corundum phase is retarded by presence of gibbsite, what could be detected by the specific surface area with a BET of 30 m²/g against 19 m²/g.

### Example 11

The particles prepared by the method of this example are particularly appropriate for applications such as polishing. 60 wt % of relatively coarse aluminum trihydroxide Martinal™ OS (d₅₀ approx. at 30 μm with top cut at <100 μm, i.e., no particles of 100 microns and greater) was suspended in 40 wt % de-mineralized water to make a slurry. The slurry was applied to a porous support (a polyurethane sponge with an average pore diameter of 0.4 mm) and adsorbed in the pores of the support. The supported slurry was then heated from room temperature to 1200° C. within 1 h in a stationary electric furnace, followed by annealing for 1 hour to alpha alumina at 1200° C. The BET of the calcined product was measured at 8 m²/g. The agglomerate size of the initial Martinal™ OS dictates the grain size of the calcined product. A further milling step can be conducted according to the requested final particle/aggregate size by desagglomeration of the soft bulk and the relictual status of the initial feedstock-aggregates, and even to the primary grain size of the calcined product, and finer particles thereof. The excessive milling is the determining factor of the final grain size.

### Examples 12 and 13

The particles prepared by the method of this example are particularly appropriate for applications such as polishing and abrasives, as well as for use as an adsorbent for water or other ions and compounds.

A dispersion/sol of pseudo boehmite (15 wt % Disperal P3) in balance with 85% de-mineralized water is applied to a polyurethane sponge having an average pore diameter of 0.15 mm. The saggar with the loaded sponge was placed in a stationary electric furnace and then treated at 600° C. for 1 h after temperature rising over 1 h from 20° C. to the desired temperature. This version is aimed to adsorptive application (with a resulting BET surface area of 230 m²/g).

The other option is based on a 1 h heating-up time from 20° C. to 1200° C. and subsequent annealing for 1 h at 1200° C. The high temperature sample was ground in a mortar (2 min) with a resulting BET surface area at 9 m²/g indicating a high degree of alpha alumina (>85 wt %). Depending on the purpose of the polishing application, the granulate can be milled to the required particle size distribution.

### Examples 14 and 15

The particles prepared by the method of this example are particularly appropriate for applications such as polishing and abrasives.

5.8 wt % alpha alumina seeds having an average fineness <0.30 μm were combined in a 2:1 weight ratio with (11.5 wt %) of pseudo boehmite Disperal P3, with a balance of 82.7 wt % of de-mineralized water. The components were homogeneously stirred with an Ultra-Turrax T25 for 5 minutes to give a suspended dispersion. The suspended dispersion, was divided into 2 fractions. Each was applied at one's own to a saggar-inserted polyurethane support having an average pore diameter of 0.4 mm. Both samples were heated in a stationary electric furnace. For the first attempt the heating ramp was 1 h to the maximal temperatures of 1000° C.

In the 2^{nd} case the up-heating was 1 h to the maximal temperatures of 1200° C. The independent treatments at the maximal temperature were at a retention time of 1 h each, giving alpha phase aluminas having BET surface areas of 19 m²/g and 8 m²/g, respectively. Before BET measurement the samples were slightly crushed with a pestle in a mortar for a few seconds.

### Examples 16 and 17

The particles prepared by the method of this example are particularly appropriate for applications such as polishing, abrasives and ceramics.

A mixture formed as in Examples 14 and 15, except that super finely sized aluminum trihydroxide Martinal OL-107 LEO was replaced by Martinal™ 111 LE as a component of the homogenized formulation. The component amounts are as follows:
49 wt % de-mineralized water
6.6 wt % Disperal P3
3.9 wt % alpha alumina seeds
40.5 wt % Martinal™ OL-111 LE
   The components were homogeneously mixed with an Ultra-Turrax T25 for 5 minutes to give a suspended dispersion. The suspended dispersion, was divided into 2 fractions. Each was applied at one's own to a saggar-inserted polyurethane support having an average pore diameter of 0.4 mm. Both samples were heated in a stationary electric furnace. For the first attempt the heating ramp was 1 h to the maximal temperatures of 1000° C. In the 2^{nd} case the up-heating was 1 h to the maximal temperatures of 1200° C. The independent treatments at the maximal temperature were at a retention time of 1 h each, giving alpha phase aluminas having BET surface areas of 29 m²/g and 5.5 m²/g, respectively. Before BET measurement the samples were slightly crushed with a pestle in a mortar for a few seconds.

### Examples 18 and 19

The particles prepared by the method of this example are particularly appropriate for applications such as polishing, abrasives and ceramics.

A mixture formed as in Examples 16 and 17, except that oleic acid was added. The component amounts are as follows:
47 wt % de-mineralized water
1.3 wt % oleic acid
6.5 wt % Disperal P3
2.9 wt % alpha alumina seeds
42.3 wt % Martinal™ OL-111 LE
   The Disperal P3 was dispersed in the de-mineralized water. Afterwards, the powdery gibbsite Martinal™ OL-111 LE and alpha alumina seeds were added, and all compounds, including the oleic acid, were homogeneously mixed together. The slurry were split into 2 fractions for two alternative thermal treatments. The aqueous slurry was poured on a saggar-inserted polyurethane support having an average pore diameter of 0.6 mm. The sponge inlet-saggar systems were placed in a stationary electric furnace and heated in one run from room temperature to maximum temperatures of 1000° C. and in the other run to a maximum temperature of 1200° C., respectively, within 1 hour, remaining at this maximum temperature for an additional hour. The results after annealing at 1000° C. and 1200° C. are consistent in the specific surface areas with Examples 16 and 17, having BET measurements of 34 m²/g and 6 m²/g, respectively. Before BET measurement the samples were slightly crushed with a pestle in a mortar for a few seconds. The granulates of Examples 18 and 19 tend to provide a slightly harder granule texture.

### Examples 20 and 21

The particles prepared by the method of this example are particularly appropriate for applications such as polishing, abrasives and ceramics. 22 wt % alpha alumina seeds were suspended in de-mineralized water (78 wt %). The suspension was split into 2 fractions for two alternative thermal treatments. The aqueous suspension was poured on a saggar-inserted polyurethane support having an average pore diameter of 0.3 mm. The saggar/support/slurry combination were placed in a stationary electric furnace and heated, one from 20° C. to a final temperature of 1200° C. within 1 h with a retention time of 1 h at maximum temperature, the other up to 1400° C. within 1 hour, and residence for 1 h at maximum temperature. The samples were manually desagglomerated for 1 minute with a mortar. The measured BETs of the mortar treated samples were 7 m²/g and 2.5 m²/g, respectively, which indicates that grain growth occurred at this high temperature level.

### Examples 22 and 23

The particles prepared by the method of this example are particularly appropriate for applications such as polishing, abrasives and ceramics.

The economics of the method can be improved by measures such as is done here: increasing solid content and aluminum trihydroxide content. Compare to Examples 16 and 17. The component amounts are as follows:
35.1 wt % de-mineralized water
4.7 wt % Disperal P3
2.2 wt % alpha alumina seeds
58 wt % Martinal™ OL-111 LE
   The Disperal P3 was dispersed in the de-mineralized water to form a dispersion. The gibbsite Martinal™ OL-111 LE powder and alpha alumina seeds were added to the dispersion, and all compounds were homogeneously mixed together. The suspension was split into 2 fractions for two alternative thermal treatments. The aqueous suspension was poured on a saggar-inserted polyurethane support having an average pore diameter of 0.6 mm. The sponge inlet-saggar systems were placed in a stationary electric furnace and heated, one was heated from room temperature to temperature of 1000° C., and the other from room temperature to a temperature of 1200° C. In both cases the up-heating period took 1 h, and the retention time was at 1 additional hour. The resulting particles, were ground via a mortar grinder for 5 min resulting in a BET (1000° C. sample) of 32 m²/g, and a BET (1200° C. sample) of 6 m²/g. The results after annealing at 1000° C. and 1200° C., respectively, are in accordance with the determined BET values of the examples 6.1 and 6.2, 10,1 and 10.2, 11.1 and 11.2 also measured at the same BET-ranges of 30 m²/g and 6 m²/g. All examples is common, that super finely sized aluminum hydroxide is one major component of the formulation.

### Examples 24 and 25

The particles prepared by the method of this example are particularly appropriate for applications such as polishing, abrasives and ceramics.

As with Examples 22 and 23, a small amount of oleic acid has been added. Oleic acid might be used to affect the texture of the agglomerate network and the size of the resultant particulate and primary crystal. The component amounts are as follows:
39.4 wt % de-mineralized water
0.9 wt % oleic acid
4.4 wt % Disperal P3
2 wt % alpha alumina seeds
53.3 wt % Martinal™ OL-111 LE

The Disperal P3 was dispersed in the de-mineralized water to form a dispersion. The Martinal™ OL-111 LE and alpha alumina seeds were added to the dispersion, and all compounds, including the oleic acid, were homogeneously mixed together. The aqueous slurry was poured onto two polyurethane supports (sponges) having an average pore diameter of 0.6 mm. Each sponge inlet-saggar systems were placed at one's own in a stationary electric furnace and heated up from room temperature to maximum temperatures of 1000° C. and 1200° C., respectively, within 1 hour. The samples were kept at their respective maximum temperatures for an additional hour, and the resulting particles were ground via a mortar grinder for 5 min, giving BET surface areas of 34 m²/g, and 6 m²/g, respectively. The results after annealing at 1000° C. and 1200° C. are close in BET values with Examples 9 and 10, 16 and 17, 18 and 19, 22 and 23 in providing a BET range of 30 m²/g and 6 m²/g, respectively. Super finely sized aluminum hydroxides is the major component of the formulation. A visible change in texture couldn't be observed. See Examples 24 and 25. In affecting the grain's shape and its size by crystal growth control, whether it is inhibition or promotion, the ability of polishing is improved. Further synergistic effects as hardness, smoothness, abrasiveness, texture of the grain boundaries, increased mechanical toughness also depend on the controlled crystal growth conditions.

MgO can be used as a dopand in combination with an Al₂O₃ component in the formation of magnesium aluminate as a synergist for an abrasive grain, but instead, the addition of spinel MgO.Al₂O₃ as a sole phase can promote similar properties.

If the feedstock undergoes an alpha alumina transition then primary crystal growth is involved. If the system works below the alpha transition—for instance in an temperature region of an gamma alumina product, which is dedicated to the adsorption of hazardous ions as fluoride, phosphate, or arsenic solutions, then in this case grain growth doesn't play an important role. In the lower temperature range the porosity and specific surface are decisive properties for rating the performance.

Alpha alumina/corundum seeds in the dispersed pseudo boehmite matrix promote the transition from pseudo boehmite to alpha alumina. The transition might occur at a reduced temperature and the crystal growth might be controlled in annealing at a lowered temperature. The dissolved pseudo boehmite arranges and solidifies around the seed, and the corundum lattice of the seed affects the formation of the alpha alumina, according to the corundum crystal lattice, at a lower energy level.

The particle size of the calcined product is controlled by the intrinsic properties of the feedstock. In the case of heterogeneous nucleation the size of the seeds and the number of seeds (weight ratio) have an impact on lowering the transition temperature and on increasing the degree of alpha formation, which should be almost complete. The higher the seed content the higher the reduction of the transition temperature. Because of seeding the formation of the interlinked theta phase at 1000/1100° C. is suppressed. The transformation enthalpy to alpha is lowered and multiple nucleation sites are available on the alpha seed's surface for alpha alumina formation.

In the contrary in case, that seeds are not present, and homogeneous nucleation would be controlled by the degree of the thermal treatment temperature profile, time, and maximum temperature. The thermal treatment affects the degree of transition and the final particle size. The higher the transition, the coarser the obtained particle size. The pore size of the support limits the size of the loosely bound agglomerate. By use of a polymeric support it is presumed, that the interconnecting matter of the pore system with its edges and contact points functions as nucleating aid. The remains of burnt carbon can also function as nucleation agent.

### Example 26

In the present example, a magnesium salt component has been included in the slurry. The particles prepared by the method of this example are particularly appropriate for applications such as polishing, abrasives, ceramic substrates, ceramic crucibles, and as a co-feedstock for oxide ceramics. The component amounts are as follows:
82.2 wt % de-mineralized water
10.4 wt % Disperal P3
0.35 wt % alpha alumina seeds
7.1 wt % MgCl₂.6H₂O

The Disperal P3 was dispersed in the de-mineralized water to form a dispersion. Afterwards, the alpha alumina seeds were added, and all compounds, including MgCl₂.6H₂O, were homogeneously mixed together. The aqueous slurry was applied to a saggar-inserted porous polyether support having an average pore size of 2.5 mm. As the slurry was quite viscous, it was applied to the sponge by intense manual pressing into and soaking of the support. The sponge inlet-saggar system was placed in a stationary electric furnace and the temperature was raised from room temperature to 1000° C. in about 1 hour, and annealed at 1000° C. for an additional 1 hour. The resulting agglomerates had a BET of 36 m²/g.

### Examples 27 and 28

Some salts affect the interfacial double layer (DLVO theory), which in some cases leads to thickening, gelling. The isoelectric point of the dispersion/suspension also affects thickening.

In the present example, a cerium salt component has been included. The particles prepared by the method of this example are particularly appropriate for applications such as polishing, abrasives and ceramics. The component amounts are as follows:
89.0 wt % de-mineralized water
9.6 wt % Disperal P3
0.3 wt % alpha alumina seeds
0.7 wt % cerium acetate hydrate (0.4 wt % CeO₂), in water and 0.4 wt % acetic acid

The cerium acetate hydrate was homogeneously mixed in the total quantity of the water, which was heated at 60° C. and conditioned with acetic acid in order to partially dissolve the acetate to form an aqueous suspension. In the next step the Disperal P3 was added to the aqueous suspension and dispersed. Afterwards, the alpha alumina seeds were added, and all compounds, were homogeneously mixed together (with an Ultra-Turrax) for a further 5 min. The sponge was placed in a saggar. The aqueous slurry was applied to a porous polyether support having an average pore size of 2.5 mm. As the shiny was of high viscosity, it was applied to the sponge by manual pressing and consequent soaking. The sponge inlet-saggar system was placed in a stationary electric furnace and heated from room temperature to 1000° C. over a time period of an hour. The sample was heated at this temperature for 1 hour. The resulting agglomerates had a BET of 53 m²/g. The X-ray diffraction pattern indicates 3 phases the presence of corundum, delta alumina, and cerianite phases.

Another annealing trial was conducted in the same manner, only differences, it was heated to-a maximum temperature of-1200° C. and maintained at this temperature for 2 hours, resulting in a BET of 8.1 m²/g. The X-ray diffraction pattern depicts 2 phases the corundum, and the cerianite phases. The primary crystals of this high temperature version are fairly homogeneously distributed in the agglomerate, and the primary crystals are present in a narrow range of 200 to 350 μm.

In contrast to the aforementioned Examples 7 fluoride freemineralizers and growth-controlling additives were used. For instance cerium acetate promotes the making of submicron fillers and polishing agents.

### Example 29

The particles prepared by the method of this example are particularly appropriate for applications such as polishing and technical ceramics. lapping of silicon wafers. The component amounts are as follows:
44.6 wt % Al(OH)₃, Martinal™ OL-111 LE
0.26 wt % TiO₂
55.1 wt % de-mineralized water
   All components were homogeneously mixed and poured onto a polyether porous support (average pore size of 2.5 mm) inserted in a saggar. The saggar-inserted support system was directly placed in a stationary electric furnace.

An up-heating was implemented in 3 stages:
From room temperature to 400° C. within 40 min and retention period per 1 hour
From 400° C. to 800° C. within 40 min and retention period per 1 hour
From 800° C. to 1200° C. within 40 min and retention period per 2 hours.

The agglomerates were crushed in a mortar grinder for 10 min. The thermal treatment resulted in a BET of 10 m²/g, and the grain size was measured with following values: d₁₀=0.7 μm; d₅₀=2.5 μm; d₉₀=14 μm; d₁₀₀=32 μm. By X-ray diffraction the corundum phase was identified at 73%, kappa phase at 19%, and theta phase at 8%.

### Example 30

The particles prepared by the method of this example are particularly appropriate for applications such as polishing and technical ceramics. lapping of silicon wafers. The component amounts are as follows:
41.4 wt % Al(OH)₃, Martinal™ OL-111 LE
0.75 MnCl₂.4H₂O wt %
57.8 wt % de-mineralized water

All components were homogeneously mixed and poured onto a polyether porous support (average pore size of 2.5 mm) inserted in a saggar. The saggar-inserted support system was directly placed in a stationary electric furnace.

An up-heating was implemented in 3 stages:
From room temperature to 400° C. within 40 min and retention period per 1 hour
From 400° C. to 800° C. within 40 min and retention period per 1 hour
From 800° C. to 1200° C. within 40 min and retention period per 2 hours.

The agglomerates were crushed in a mortar grinder for 10 min. The thermal treatment resulted in a BET of 8.5 m²/g. The corundum phase was measured by X-ray diffraction at >95%. The SEM photograph indicates a primary particle size of around 0.2 μm.

### Example 31

The particles prepared by the method of this example are particularly appropriate for applications such as lapping and filler materials in polyamides. The component amounts are as follows:
71.2 wt % Al(OH)₃, Martinal™ OL-107 LEO
0.5 wt % AlF₃
0.3 wt % Dolapix™ PC 21
28 wt % de-mineralized water

Dolapix was dispersed in water to form a dispersion. The hydroxide and fluoride were added to the dispersion. The compounds were homogeneously mixed and poured on a porous polyether support inserted in a saggar having an average pore size of 0.3 mm. The sponge inlet-saggar system was directly placed in an electric furnace at 1200° C. The holding time at maximum temperature was 2 hours. The powder was gently desagglomerated with a pestle in a mortar. The resulting primary crystal is sized between 2 to 6 μm as indicated by SEM. The BET was determined at 0.7 m²/g.

Alpha alumina of lower calcination degree can also function in the transition sequence of alumina being transformed to an alpha alumina of higher calcination degree, which can be promoted by mineralizers and increase of temperature. In both Examples 32 and 33 an amount of a fluoride compound (AlF₃, a mineralizer), was added to a high solid content suspension of alpha alumina. The homogenized suspension with the alpha alumina feedstock was applied to a saggar-inserted polyurethane support having a pore diameter of approx. 0.6 mm by soaking, and directly fired for 1 hour at 1200° C., a temperature generally close to, or preferably, lower than the manufacturing temperature of the already alpha transformed alumina feedstock. Mineralizers and increased temperatures, used together, can promote the calcination to alpha alumina of increased amount of alpha phase. Furthermore, an increase of temperature alone can promote crystal growth, but to a significantly less extent than that in the presence of a mineralizer. The crystal formation reaction can be triggered by the additive more strongly, even if the post-maximum-temperature treatment is relatively low (i.e., at the level of the previous manufacturing temperature at a range of 1250 to 1350° C., or even slightly lower up to 100° C. less).

Mineralizers promote the crystal growth of alpha alumina, even if the mineralizer is used as a vapor/gas or in the liquid or solid state, which affect alpha transition and crystal growth. Fluorides, for instance, preferentially promote the growth in one plane of the crystal lattice, causing the particles to grow into a platy shape. Boron-type additives, such as H₃BO₃, 3ZnO.3B₂O₃.3.5H₂O, Na₂B₄O₇.10 H₂O, and the like, promote a more globular shape. In case of a boron-fluoride containing compound as NaBF₄ the dominating effect is caused by fluoride in the formation of platelets. Chlorides-containing additives, such as, for example Cl₂, (NH)₄Cl, AlCl₃, and the like, generally promote the growth of alpha alumina having rounder shapes. For example, mineralization could be done with Cl₂ gas.

As a general matter, the addition of a mineralizer often promotes particle growth at the expense of seeding/crystal initiation, and results in larger crystals.

### Example 32

The particles prepared by the method of Example 32 are particularly appropriate for applications such as lapping and filler materials. The component amounts are as follows:
40 wt % de-mineralized water
59.5 wt % of milled alpha aluminum oxide, Martoxid™ PN-202 (BET approx. 12 m²/g)
0.5 wt % AlF₃, super fine powder as crystal growth promoter (mineralizer)
   In this example, alpha alumina, i.e. highly phase transformed feedstock of around 85% alpha phase was used as a reactant for the formation of higher transformed alpha aluminum oxide at around 98% and even higher alpha phase. The AlF₃ was added to a high solid content suspension of alpha alumina created by mixing the Martoxid PN-202 with the de-mineralized water. The homogenized suspension was soaked into a saggar-inserted polyurethane support having a pore diameter of approx. 0.6 mm. The soaked polyurethane support was directly fired at 1200° C. for 1 hour. The final product has a significantly reduced specific surface area (BET) of 0.6 m²/g compared to the initial one at 12 m²/g.

The PN-202 is built up by 3 to 4 μm aggregates containing primary crystals in the range of 300 to 400 μm. The PN-202 after post-calcination significantly has greater grown primary crystals, some platelets are about 15 μm. Even the smaller growth inhibited primary crystals show an enlarged size of 1 to 2 μm.

### Example 33

The particles prepared by the method of Example 33 are particularly appropriate for applications such as lapping and filler materials. The component amounts are as follows:
30 wt % de-mineralized water
69.5 wt % alpha aluminum oxide (corundum phase) Al₂O₃, Martoxid™ MRS-1 (BET approx. 3.5 m²/g)
0.5 wt % NaBF₄, solved in water (mineralizer)

In this example, alpha alumina, i.e. highly phase transformed feedstock of around 95% alpha phase was used as a reactant for the formation of higher transformed alpha aluminum oxide at around 98% and even higher alpha phase. The NaBF₄ was added to a high solid content suspension of alpha alumina created by mixing the Martoxid MRS-1 with the de-mineralized water. The NaBF₄ was soluble in the water phase. The homogenized suspension was soaked into a saggar-inserted polyurethane support having a pore diameter of approx. 0.6 mm. The soaked polyurethane support was directly fired at 1200° C. for 1 hour. The resulting particles, gently ground via pestle, had a BET of 1 m²/g compared to 3.5 m²/g of the feedstock MRS-1.

The MRS-1 is built up by 0.5 to 2 μm primary crystals. It is completely desagglomerated. The MRS-1 after post-calcination considerably has greater grown primary crystals. The growth factor is about 2. There are rounded and partially platy shaped individuals by influence of boron and fluoride. Pure aluminum oxide can be made from pure aluminum containing feedstocks. These compounds could be aluminum salts and alumina compounds in presence and absence of alpha corundum seeds. For instance, various aluminum salts, such as, for example, aluminum chloride hexahydrate, ammonium alum, aluminum formate, aluminum acetate, aluminum nitrate, and the like, alumina compounds such as, i.e., precipitated boehmite, (re)crystallized hydrothermal boehmite, colloidal boehmite, pseudo boehmite, and chemical precursors as hydrolyzed aluminum alkoxides can be deployed for the preparation of superfine, submicron particles. Alumina precursor dispersions, which are thermally treated in porous supports at temperatures greater than 1000° C. will generally result in alpha alumina, which can be desagglomerated to submicron powders, which are suitable for specific polishing and performance ceramic applications. Said products can be applied depending on purity, primary crystallite size, and grain size distribution for sapphire synthesis, engineering ceramics, bio-ceramics, translucent ceramics, hi-performance polishing, and as carrier and encapsulant for phosphorus salts and rare-earth compounds, etc.

For salt solutions the rate of the increase of temperature and the realized final temperature range including retention time (temperature profile) are crucial/decisive, respectively are the limiting and determining factors. As far as temperature is increased liquid is volatilized/evaporated. The development of seeds (size and increased number of seeds) and the formation of crystalline matter continuously progresses affecting seed growth, domain growth, and agglomerate growth, in a more or less uncontrolled manner (FIG. 13). The material might undergo several phase transitions. The pore itself and remains of the combusted polymeric support might act as seeding promoter. Each kind of contamination functions as a seed. In the alpha range, crystal growth is controlled by the addition of synthetic and distinct alpha alumina seeds. There is some geometrical approach. A seed with a diameter of 0.3 μm has a volume of 0.014 μm³. Growing a crystal to a diameter of 0.6 μm results in a volume of 0.113 μm³, which is 8 times greater.

As shown in FIG. 14 aluminum triformate can function as feedstock for pure aluminas, and even in combination with other kind of aluminas and mineral compounds. An example of the foregoing is Example 34.

### Example 34

The particles prepared by the method of this example are particularly appropriate for polishing applications. The component amounts are as follows:
40 wt % of OL-107 LEO
60 wt % aluminum formate solution with 40 wt % active formate
40 wt % of OL-107 LEO was homogenously suspended in 60 wt % aluminum formatolution providing an active formate content of 40 wt %. The solution was applied to a saggar-inserted porous polyether sponge having an average pore size of approx 2 5 mm such that it filled the interstices of the sponge. The sponge-inlet-saggar system was placed in a stationary electric furnace. An up-heating was implemented in 3 stages:
From room temperature to 400° C. within 40 min and retention period per 1 hour;
From 400° C. to 800° C. within 40 min and retention period per 1 hour;
From 800° C. to 1150° C. within 40 min and retention period per 2 hours.

The annealed product corresponds to a dry substance of approximately 80 wt % Al₂O₃ from aluminum trihydroxide and approximately 20 wt % Al₂O₃ from aluminum triformate. The agglomerates were crushed in a mortar grinder for 5 min. The BET has been determined at 12.7 m²/g. The particle size distribution after milling in a disk vibration mill (Siebtechnik) for 15 seconds is at d₁₀=0.7 μm; d₅₀=1.7 μm; d₉₀=3.3 μm; d₁₀₀=6 μm.

Ceramic spinel pigments, such as, for example, cobalt blue, from Aluminum trihydroxide precursors can be easily made. Suspending stoichiometric ratios of the cobalt-compound and alumina precursor and firing at 1200° C. will lead to the formation of synthetic spinel. The manufacture of the different colored spinel types varies in chemistry. The preparation of solid solutions of other spinel types as MgO.Al₂O₃, or mineral compounds and their solid solutions belonging to other crystalline structures than spinel as aluminum titanate, cordierite, and others are also common in the ceramic industries.

### Example 35

The particles prepared by the method of this example are appropriate for applications such as the preparation of spinel, spinel-based pigments, and colored bodies. 39.2 wt % Co(II)SO₄.7H₂O was solved by heating at 80° C. in 39.1 wt % de-mineralized water and subsequently 21.8 wt % Al(OH)₃, Martinal™ OL-111 LE were added. The stoichiometric ratio of CoO to Al₂O₃ is about 1:1. All components were homogeneously mixed, poured on a saggar-inserted polyether porous support with an average pore size of 0.3 mm. The slurry was adsorbed inside the pores of the support. The sponge inlet-saggar system was heated at a rate of 330° K per hour from room temperature to 1200° C. in a stationary electric furnace. Holding time at maximum temperature was 2 hours. The X-ray diffraction pattern of the annealed product reveals that the particles are mostly cobalt aluminate, with a minor portion being alpha alumina. The corresponding BET is of 7.5 m²/g. Particle size distribution after smooth des agglomeration in a mortar grinder for 2 min is: d₁₀=0.5 μm; d₅₀=1.4 μm; d₉₀=26 μm; d₁₀₀=56 μm.

### Example 36

The particles prepared by the method of the present invention are appropriate for applications such as the preparation of spine! (particularly super-fine ceramic grade), spinel-based pigments, and colored bodies. The component amounts were as follows:
13.6 wt % Mg(OH)₂, Magnifin™ H10
36.4 wt % Al(OH)₃, Martinal™ OL-104 LE
50 wt % de-mineralized water

All components were homogeneously mixed and poured on a saggar-inserted polyether porous support with an average pore size of 0.4 mm The-slurry was absorbed into the interstices of the support. The sponge inlet-saggar system was heated at a rate of 330° K per hour from room temperature to 1200° C. in a stationary electric furnace. Holding time at maximum temperature was 1 hour. The X-ray diffraction pattern of the product clearly indicates transformation to magnesium spinel with minor traces of periclase.

### Example 37

A second trial at the same heat rate and a maximum temperature of 1400° C. during 1 hour was conducted in the same manner resulting in an X-Ray diffraction pattern of magnesium spinel. This product was smoothly ground in a mortar grinder for 5 min resulting in the following particle size distribution: d₁₀=0.58 μm; d₅₀=1.77 μm; d₉₀=26.9 μm; d₁₀₀=56 μm.

### Example 38

The particles prepared by the method of this example are appropriate for applications such as the preparation of spinel, spinel-based pigments, and colored bodies. The component amounts are as follows:
11.8 wt % MgCO3, pharmaceutical grade with PSD d₅₀=11 μm and top cut at 45 μm
21.3 wt % Cr₂O₃, pro analysis with PSD d₅₀=1 μm and top cut at 20 μm
66.8 wt % de-mineralized water.

All components were homogeneously mixed. The dispersion was amended in the amount of 0.03% dispersant Antiprex 6340 (active substance) in order to improve the fragility of the agglomerate. The dispersion was poured on a saggar-inserted polyether porous support having an average pore size of 0.4 mm. The slurry was absorbed into the interstices of the support. The sponge inlet-saggar system was heated at a rate of 330° K per hour from room temperature to 1400° C. in a stationary electric furnace. Holding time at maximum temperature was 1 hour. The X-ray diffraction pattern clearly indicates transformation to magnesiochromite phase in the level of 95 wt % with a minor share of chromium oxide at 5 wt %. The particle size distribution after smooth desagglomeration in a mortar grinder for 5 min is d₁₀=0.89μm; d₅₀=5.3 μm; d₉₀=12.8 μm; d₁₀₀=24 μm, corresponding with a BET of 1.9 m²/g.

### Example 39

The particles prepared by the method of the present invention are appropriate for applications such as the preparation of spinel and colored bodies. The component amounts are given below. In this example, alpha alumina, i.e. highly phase transformed feedstock, was used as a reactant for the formation of spinel.
14.6 wt % Mg(OH)₂, Magnifin™ H10
25.5 wt % alpha aluminum oxide (corundum phase) Al₂O₃, Martoxid™ MRS-1
59.9 wt % de-mineralized water

All components were homogeneously mixed—added all at once—and poured on a saggar-inserted polyether porous support with an average pore size of 0.4 mm. The slurry was absorbed into the interstices of the support. The sponge inlet-saggar system was heated at a rate of 330° K per hour from room temperature to 1400° C. in a stationary electric furnace. Holding time at maximum temperature was 1 hour. The X-ray diffraction pattern of the product clearly indicates a transformation to magnesium spinel. The BET of the annealed product is 2.7 m²/g.

An SEM demonstrates, the grain size of the resulting spinel, which is at an estimated d₅₀ of about 1.5 μm, has not changed significantly in grain size compared to the initial feedstock MRS-1. Alternatively, stoichiometric spinel can be produced using an alpha alumina feedstock. Apart from that pertain the conditions of Example 35. As anticipated., the mineral mixture reacts to form spinel phase.

### Example 40

The particles prepared by the method of the present invention are appropriate for applications such as the preparation of aluminum titanate which is a material used in engineering ceramics. It was synthesized by a one to one stoichiometric ratio of anatase and alumina, as well as traces of amorphous silica, which was used to prevent the decomposition of the aluminum titanate's crystal lattice. The reactant component amounts are as follows:
18.3 wt % TiO₂, Kronos 1001, anatase with PSD d₅₀=0.5 μm and a top cut at 4 μm as measured by a Cilas laser diffractometer
35.8 wt % Al(OH)₃, Martinal™ OL-111 LE
0.1 wt % amorphous SiO_{2,} Aerosil 200
45.8 wt % de-mineralized water.

All components were homogeneously mixed such that an aqueous suspension was formed, and the suspension was allowed to soak into a saggar-inserted polyether porous support having an average pore size of 0.4 mm. The slurry was absorbed into the interstices of the support. The sponge inlet-saggar system was placed in a stationary electric furnace and heated from room temperature to 1400° C. over 1 hour's time. The holding time at maximum temperature was 1 hour. The X-ray diffraction pattern clearly indicates the transformation to aluminum titanate in a level of 99.4 wt % with the balance of rutile at 0.6 wt %. The non-treated final product has a BET of 0.4 m²/g.

In other embodiments, the present invention can be used, subsequently to thermal treatment, without particulation, i.e. in its agglomerated state. For example, when prepared from precursors including a binding phase such as aluminum phosphate, amorphous aluminum trihydroxide, (re)hydrated alumina, pseudo boehmite, peptizable boehmite, amorphous silica, water glass, concrete, and inorganic gels as bentonite, and the like. The use as adsorbent or catalyst generally requires a thermal treatment at 350° C. and higher as adsorptive activity is required. The resulting non-desagglomerated agglomerate may be used in applications such as an adsorbent for water purification or as a catalyst, for instance for the AO-process in the manufacture of H₂O₂.

In general, the slurry/dispersion saturated pores of the support functions as spatial elements for the precipitation of the solid phase and the thermal consolidation of the granules.

### Example 41

The granulates prepared in this example are appropriate for applications such as adsorbents which can be used in applications such as catalysis and liquid purification. The component amounts are as follows:
5.5 wt % aluminum phosphate (active substance) Lithopix™ P1
56.7 wt % Martinal™ OL-111 LE
37.8 wt % de-mineralized water.

The three components were homogeneously mixed together into a slurry. The saggar-inserted sponge (polyether with pore diameter 2.5 mm) was saturated with the suspension such that the suspension was absorbed into the interstices of the support. Granulating was accomplished by use of the binder aluminum phosphate. The sponge inlet-saggar system was placed in a stationary electric furnace and heated from room temperature to 600° C. per 1 hour. The holding time at maximum temperature was 1 hour. 72 wt % of the non-desagglomerated granules are greater than 1.6 mm (d₇₂=1.6 mm) The BET of the non-desagglomerated granulated sample is at 155 m²/g. This example shows, it is possible to combust a support, to vaporize the liquid phase, and to achieve by means of the binding agent a consolidated granulated texture of the remaining matter.

A proper granulate with granule sizes close to the pore size of the support results. The granule size is quite close to 2.5 mm.

### Example 42

The granulates prepared in this example are appropriate for applications such as adsorbents which can be used in applications such as catalysis and liquid purification. The reactant components are as follows:
8.2 wt % AlOOH, Sasol Disperal P3™
45.3 wt % Martinal™OL-111 LE
46.5 wt % de-mineralized water

As discussed in Example 12, a dispersion of Disperal P3, which provides binding capabilities, was thermally treated at 600° C. The resulting granulate, deriving from this pseudo boehmite, solely, belongs to the lower transition alumina sequence, which is indicated by a resulting BET of 230 m²/g. In addition to that former experiment aluminum hydrate has been added to the pseudo boehmite dispersion. The saggar-inserted sponge (polyether with pore diameter 0.4 mm) was saturated with the suspension and the slurry was absorbed into the interstices of the support. Granulating was accomplished by use of the binding component pseudo boehmite Disperal P3. The sponge inlet-saggar system was placed in a stationary electric furnace and heated from room temperature to 600° C. per 1 hour. The holding time at maximum temperature was 1 hour. The non-desagglomerated average granule diameter is close to 0.4 mm, which is in a fairly good agreement with the initial pore size of the sponge. The BET of the granulated sample is at 188 m²/g, also according to the lower transition alumina range as already shown in Example 12.

A proper granulate with granule sizes close to the pore size of the support results. The estimated average granule size is close to 0.4 mm.

The size of the undesagglomerated granules correspond with the pore sizes within limits It has to be considered, that the pore is the spatial element for granule formation, but the concentration of the slurry has an additional effect on granule-shrinkage. If the slurry is of low solid content, the granule might be more porous and might shrink by aggregation due to the present capillary forces and adhesion forces during the evaporation of the liquid compound(s).

### Example 43

A further annealing trial was conducted in the same manner, but in the alpha alumina formation range. The sponge inlet-saggar system was placed in a stationary electric furnace and heated from room temperature to 1200° C. per 1 hour. The holding time at maximum temperature was 1 hour. The BET of the non-desagglomerated granulated sample is at 12 m²/g resulting in a material. In the ground state it is suitable for sensitive high performance polishing.

### Example 44

The granulate prepared in this example are appropriate for applications such as adsorbents which can be used in applications such as water purification. The reactant component amounts are as follows:
3.7 wt % AlOOH, Sasol Disperal P3™
15.1 wt % FeCl₂.4H₂O, pure grade
20.6 wt % Martinal™ OL-111 LE
60.6 wt % de-mineralized water .

The compounds were homogeneously mixed. 0.3 wt % of the dispersing agent Viscodis 177 were added, in order to reduce the viscosity of the highly viscose slurry. The suspension was poured on a saggar-inserted porous polyurethane support having an average pore size of 0.4 mm, and the slurry was absorbed into the interstices of the support. The sponge inlet-saggar system was placed in a stationary electric furnace and heated from room temperature to 600° C. per 1 hour. The holding time at maximum temperature was 1 hour. Granulating was accomplished by use of the binding component pseudo boehmite Disperal P3 in accordance with the Examples 42 and 43. The measured BET of the non-desagglomerated granulate is at 110 m²/g. The granule size distribution is 65 wt % >250 μm.

### Example 45

The granulates prepared in this example are appropriate for applications such as adsorbents which can be used in applications such as water purification. The reactant component amounts are as follows:
5 wt % aluminum phosphate (active substance) Lithopix™ P1
11.4 wt % iron powder, 100% <63 μm
52.3 wt % Martinal™ OL-111 LE
31.3 wt % de-mineralized water.

As in Example 41—except the addition of iron powder—the compounds were homogeneously mixed. The suspension was poured on a saggar-inserted porous polyurethane support having an average pore size of 0.4 mm and the slurry was absorbed into the interstices of the support. The sponge inlet-saggar system was placed in a stationary electric furnace and heated from room temperature to 600° C. in 1 hour. The holding time at maximum temperature was 1 hour. Granulating was accomplished by use of the binder aluminum phosphate following the procedure of Example 41. The resulting non-desagglomerated granulate has a BET of 115 m²/g and its granule size is 71 wt % greater than 250 μm.

### Example 46

The granulates prepared in this example are appropriate for applications such as polishing, as well for adsorbent applications such as water purification.

Pseudo boehmite Disperal P3 was not transformed to a dispersion, but instead it was simply suspended as a highly concentrated aqueous slurry of 60% solid content. The slurry was pressed into a 2.5 mm pore size support made of polyether, which was inserted in a saggar. The supported slurry was heated from room temperature to 560° C. per 1 hour. Thermal treatment was conducted at 560° C. resulting in a BET of 210 m²/g. The granulated product has a granule diameter of up to 10 mm demonstrating some growth interaction in between the open pores, indicated by the photograph below.

### Example 47

An additional trial was conducted with the same formulation at an annealing temperature of 1200° C. after up-heating from room temperature to 1200° C. for 1 hour. The BET of 6 m²/g indicates alpha alumina. The granulate can be comminuted to a powdery soft polishing agent.

### Example 48

The particles prepared by the method of this example are particularly appropriate for applications such as polishing and abrasives, as well as for use as an adsorbent for water or other ions and compounds.

A dispersion/sol of pseudo boehmite (18.6 wt % Disperal P3) in balance with 0.2 wt % acetic acid, 0.2 wt % AlC₃, 0.2 wt % MgCl₂.4H₂O, and 80.8 wt % de-mineralized water is applied to a polyether sponge having an average pore diameter of 2.5 mm. The saggar with the loaded sponge was placed in a stationary electric furnace and then treated at 600° C. for 1 h after temperature rising over 1 h from 20° C. to the desired temperature. This version is aimed to adsorptive application. The granulates BET surface area was determined at 220 m²/g. Granules of a diameter of 2 mm showed granule strength of around 20 N measured by the Pfizer hardness tester.

### Example 49

A dispersion/sol prepared in the same manner as Example 48 is applied to a polyether sponge having an average pore diameter of 2.5 mm. The saggar with the loaded sponge was placed in a stationary electric furnace and then treated at 1400° C. for 2 h after temperature rising over 1 h from 20° C. to the desired temperature. This version is aimed to polishing and ceramic applications. The granulates BET surface area was determined at 1.6 m²/g. Granules of a diameter of 2 mm showed granule strength of around 30 N measured by the Pfizer hardness tester.

### Example 50

The particles prepared by the method of this example are particularly appropriate for applications such as polishing and abrasives, as well as for use as an adsorbent for water or other ions and compounds.

A homogeneously mixed suspension of dispersed pseudo boehmite (15.4 wt % Disperal P3) in balance with 16.7 wt % Martinal OL-111 LE, 0.1 wt % acetic acid, 0.15 wt % MgCl₂.4H₂O, and 67.7 wt % de-mineralized water is applied to a polyether sponge having an average pore diameter of 2.5 mm. The saggar with the loaded sponge was placed in a stationary electric furnace and then treated at 600° C. for 1 h after temperature rising over 1 h from 20° C. to the desired temperature. This version is aimed to adsorptive application. The granulates BET surface area was determined at 200 m²/g. Granules of a diameter of 2 mm showed granule strength of around 30 N measured by the Pfizer hardness tester.

### Example 51

A homogeneously mixed suspension prepared in the same manner as Example 50 is applied to a polyether sponge having an average pore diameter of 2.5 mm. The saggar with the loaded sponge was placed in a stationary electric furnace and then treated at 1400° C. for 2 h after temperature rising over 1 h from 20° C. to the desired temperature. This version is aimed to polishing and ceramic applications. The granulates BET surface area was determined at 3 m²/g. Granules of a diameter of 2 mm showed granule strength of around 35 N measured by the Pfizer hardness tester.

### Example 52

The particles prepared by the method of this example are particularly appropriate for applications such as polishing and abrasives.

A homogeneously mixed suspension of dispersed pseudo boehmite (9.7 wt % Disperal P3) in balance with 14.9 wt % alpha seeds, 0.1 wt % acetic acid, 0.1 wt % MgCl₂.4H₂O, and 75.2 wt % de-mineralized water is applied to a polyether sponge having an average pore diameter of 2.5 mm. The saggar with the loaded sponge was placed in a stationary electric furnace and then treated at 1400° C. for 2 h after temperature rising over 1 h from 20° C. to the desired temperature. The granulates BET surface area was determined at 1.0 m²/g. Granules of a diameter of 2 mm showed granule strength of around 40 N measured by the Pfizer hardness tester.

### Example 53

A homogeneously mixed suspension prepared in the same manner as Example 52 is applied to a polyether sponge having an average pore diameter of 2.5 mm. The saggar with the loaded sponge was placed in a stationary electric furnace and then treated at 1600° C. for 2 h after temperature rising over 3 h from 20° C. to the desired temperature. Granules of a diameter of 2 mm showed granule strength of around 150 N measured by the Pfizer hardness tester. The primary grains are mostly in between 1 and 4 μm.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

Each and every patent or other publication or published document referred to in any portion of this specification is incorporated in toto into this disclosure by reference, as if fully set forth herein.

This invention is susceptible to considerable variation in its practice. Therefore the foregoing description is not intended to limit, and should not be construed as limiting, the invention to the particular exemplifications presented hereinabove.

That which is claimed is:

1. A process for the preparation of a mineral particulate, said process comprising the steps of
a) applying a transitionable material to a porous polymeric support;
b) raising the temperature of the applied transitionable material and the support to one or more temperatures for a time to give a resulting particulate or a resulting agglomerate;
c) if a resulting agglomerate is given in b), desagglomerating some or all of said resulting agglomerate to give a resulting particulate; (absorbent embodiment)
wherein said porous support is polymeric and some or all of said porous support is reduced through combustion or thermal degradation in b); or wherein a resulting agglomerate is formed and said porous support is particulated with said agglomerate and subsequently some or all of said support is separated from said resulting particulate.

2. A process as in claim 1 wherein the transitionable material is a pretransition particulate slurry, which undergoes a phase transition as a result of b), to give said agglomerate.

3. A process as in claim 2-wherein the pretransition particulate slurry comprises a slurry of particulate alumina of one or more of the following phases: gibbsite α-Al(OH)₃, bayerite β-Al(OH)₃, nordstrandite γ-Al(OH)₃, diaspore α-AlOOH, boehmite γ-AlOOH, χ-alumina, η-alumina, γ-alumina, δ-alumina, κ-alumina, θ-alumina, and α-Al₂O₃.

4. A process as in claim 2 wherein the pretransition particulate slurry comprises a stoichiometric binary or ternary mixture of particles.

5. A process as in claim 1 wherein said transitionable material is a particle-forming solution, which, as a result of b), undergoes particle formation to form particles, and, optionally, phase transition of said particles, to give said resulting particulate.

6. A process as in claim 5 wherein the particle forming solution comprises a seed particulate.)

7. A process as in claim 6 wherein said particle-forming solution comprises an additive selected from the following group: NaF, Na₂PO₃F, NaB_{F}4, CaF₂, AlF₃, cerium acetate, lanthanum carbonate, lanthanum chloride, MgO, TiO₂, Cr₂O₃, and silica.
